(19) United States
(12) Patent Application Publication
(10) Pub. No.: US 2026/0148167 A1
(43) Pub. Date: May 28, 2026

(54) SYSTEMS AND METHODS FOR AUTOMATED STRUCTURED WORKFLOWS

(71) Applicant: Avinoam Daniel Garfinkel, New York, NY (US)

(72) Inventor: Avinoam Daniel Garfinkel, New York, NY (US)

(21) Appl. No.: 19/403,551

(22) Filed: Nov. 28, 2025

Related U.S. Application Data
(60) Provisional application No. 63/725,613, filed on Nov. 27, 2024.

(51) Int. Cl. G06Q 10/0633; G06F 40/279; G06F 40/30; G06F 40/40; G06Q 30/0283

(52) U.S. Cl. CPC G06Q 10/0633; G06F 40/279; G06F 40/30; G06F 40/40; G06Q 30/0283

(57) ABSTRACT

The embodiments provide a system which receives user-provided natural-language input and processes the input to generate a structured workflow. The system analyzes the input using a Natural-Language Processing Engine to extract entities, intents, time references, and obligations, and classifies the extracted information using a Hierarchical Tag Graph. A Context Resolver identifies a governing context that includes jurisdictional or regulatory attributes. A Milestone Directed Acyclic Graph Compiler generates a milestone structure containing preconditions, action items, and verified events. A Cost Binder assigns structured cost data to the milestones, and an Engagement Generator produces an electronically signable agreement based on the milestone structure and associated cost data. A Runtime Workflow Tracker monitors the verified events and advances execution of the workflow. The system may operate across legal, administrative, commercial, or other service-based domains.

### CROSS-REFERENCE TO RELATED APPLICATIONS

The present application claims priority to U.S. Provisional Patent Application 63/725,613 filed on Nov. 27, 2024, entitled “SYSTEMS AND METHODS FOR AUTOMATED LEGAL SERVICES” the entire disclosure of which is incorporated by reference herein.

### TECHNICAL FIELD

The present disclosure relates generally to computer-implemented systems and methods for automated structured workflows for legal and other professional or rule-governed services.

### BACKGROUND

The delivery of professional services has long depended on direct human interpretation of client needs, typically expressed in unstructured natural language. Historically, whether in legal services, healthcare, construction, finance, or education, clients initiate engagement by describing their problems or goals conversationally, leaving professionals responsible for manually extracting relevant facts, determining applicable rules, and structuring a compliant workflow. This manual interpretive step has persisted for decades despite significant digital transformation across other industries. Traditional intake processes, including interviews, questionnaires, and document exchanges, were introduced as an attempt to impose structure on inherently unstructured narratives. However, these tools remained largely static and required clients to adapt to rigid formats rather than enabling systems to intelligently interpret client inputs.

As software systems evolved, early case management and workflow platforms focused primarily on organizing tasks after a human professional had already interpreted and structured the client's issue. These systems improved recordkeeping, communication, and deadline tracking, but they relied heavily on manual data entry and human judgment at the outset of every engagement. Even as natural language processing technologies emerged, their use in professional services remained limited to basic keyword extraction or template population, offering minimal assistance in understanding context, intent, or procedural requirements. Consequently, service providers continued to shoulder the burden of translating free-form narratives into structured workflows without computational support. This mismatch between unstructured inputs and structured professional processes consistently generated latency, inconsistency, and unnecessary administrative overhead.

Across regulated industries, the complexity of domain-specific rules introduced additional challenges that traditional systems were ill-equipped to address. Clients were often unaware of the procedural steps, compliance standards, or documentation requirements governing their issue, leading to incomplete submissions and repeated clarification cycles. Professionals, meanwhile, were required to manually classify matters into specialized categories, identify jurisdictional or regulatory constraints, and configure task sequences tailored to the client's scenario. Because this information was not computationally inferred or verified, workflow decisions varied significantly between professionals, creating variability in outcomes, costs, and client experiences. As a result, both clients and service providers encountered avoidable frustration and inefficiency.

Despite advancements in digital infrastructure, few systems have bridged the gap between unstructured human inputs and structured, verifiable workflows. Existing platforms excelled at storing information, coordinating communication, or automating isolated tasks, but they lacked the ability to generate milestone-driven workflows from narrative inputs or to ensure that those workflows complied with domain-specific rules. The absence of automated context detection, structured milestone generation, and dynamic cost binding limited the ability of technology to reduce friction at the earliest and most critical stage of service engagement. Without a computational method to transform natural language into actionable, multi-step workflows, users remained dependent on professionals to interpret every scenario manually. This persistent reliance on human translation of problems into structured processes represents a central shortcoming of the historical technical landscape that the present invention seeks to overcome.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a computer-implemented system comprising one or more processors and one or more memory devices that collectively automate the transformation of a script input into an executable workflow that is procedurally accurate, contextually tailored, and verifiably trackable. The system begins by receiving the script input, which may include natural-language text, voice-to-text content, or document information, and prepares it for automated analysis. Rather than requiring the user to manually categorize or structure their input, the system employs a Natural-Language Processing Engine capable of extracting entities, intents, time references, and obligations with a high degree of semantic precision. This extraction process ensures that every relevant factual and procedural aspect of the script input is captured in a structured representation. By automating this interpretive step, the invention fundamentally reduces manual triage work that previously depended on professional expertise.

Once the Natural-Language Processing Engine has prepared the structured representation of the script input, the system utilizes a Hierarchical Tag Graph to classify the input into a primary domain tag and a sub-domain tag. This Hierarchical Tag Graph includes hierarchical nodes enriched with metadata describing domain categories, sub-domain relationships, governing rules, responsible roles, required documents, and typical procedural parameters. By associating the extracted entities and intents with specific nodes in the Hierarchical Tag Graph, the system develops a precise understanding of the category and procedural nature of the matter described in the script input. This classification ensures uniformity across diverse user submissions, enabling consistent workflow formation even in highly regulated or specialized domains. The classification step therefore forms a foundational layer for subsequent workflow generation activities.

The invention further incorporates a Context Resolver to determine the governing context applicable to the script input. The governing context may depend on geographic indicators, regulatory indicators, user-selected jurisdictional data, or contextual cues embedded within the natural-language content itself. The Context Resolver evaluates these indicators using weighted inference models that are specifically designed to minimize ambiguity regarding applicable rules and procedural requirements. By determining the correct governing context at the outset, the system ensures that all subsequent workflow components accurately align with local, regional, or domain-specific mandates. This contextual alignment enhances the reliability and legality of the resulting workflow.

Using the outputs of the Natural-Language Processing Engine, the Hierarchical Tag Graph, and the Context Resolver, the system invokes a Milestone Directed Acyclic Graph Compiler configured to generate a milestone structure tailored to the primary domain tag, the sub-domain tag, and the governing context. The milestone structure comprises a plurality of milestones, each milestone containing at least one precondition, at least one action selected from a client action item or a professional action item, and at least one verified event required for completion. The Milestone Directed Acyclic Graph Compiler assembles these milestones into a Directed Acyclic Graph, establishing a deterministic execution sequence that avoids redundant loops and establishes clear dependency relationships. This compilation process ensures that procedural workflows are transparent, logically consistent, and operationally sound. Through this approach, the invention achieves a level of procedural rigor not attainable through traditional unstructured methods.

Each milestone generated by the Milestone Directed Acyclic Graph Compiler establishes a discrete, verifiable step within the broader workflow. Preconditions serve as the foundational requirements necessary to activate the milestone, whether they involve document uploads, factual confirmations, or regulatory prerequisites. The actions associated with the milestone may include client action items that users can complete independently or professional action items requiring qualified practitioners. The verified event assigned to each milestone provides an auditable checkpoint signaling successful completion. Together, these elements ensure that the workflow remains structured, measurable, and resistant to user error or omission.

The invention also integrates mechanisms for adaptively collecting additional information when the system identifies unmet preconditions within the milestone structure. The Natural-Language Processing Engine can automatically generate follow-up questions targeted to the precise information gaps that prevent milestone activation, thereby avoiding lengthy or irrelevant questionnaires. These follow-up questions reflect a computationally optimized strategy that minimizes user burden while maximizing data completeness. As users provide this additional information, the system immediately incorporates it into the milestone structure. This feedback process ensures that workflow accuracy improves continuously throughout user interaction.

A key aspect of the invention is the Cost Binder, which assigns a structured cost object to each milestone within the milestone structure. Structured cost objects include fields describing time estimates, resource allocations, professional fees, material costs, or other domain-specific cost parameters relevant to the milestone. To prevent cost instability, the Cost Binder includes a variance limiter configured to restrict cost fluctuations within predetermined bounds. This ensures that users receive predictable and trustworthy cost information, even in complex or evolving workflows. By embedding structured cost objects at the milestone level, the invention promotes transparency and improves financial planning for users and professionals alike.

After generating the milestone structure and the structured cost objects, the system uses an Engagement Generator to compile these components into an engagement agreement configured for electronic signature. The engagement agreement contains contractual terms explicitly referencing each milestone and its associated structured cost object, enabling users and professionals to engage with full visibility into the workflow. The Engagement Generator formats the agreement in a manner that meets professional, commercial, and regulatory expectations. Once executed, this agreement becomes the governing instrument for workflow execution. The seamless transition from analysis to enforceable contract represents one of the invention's core improvements.

Following execution of the engagement agreement, the Runtime Workflow Tracker assumes operational control of workflow execution. The Runtime Workflow Tracker monitors each verified event associated with the milestone structure to determine whether a milestone has been completed. When a verified event is detected, the Runtime Workflow Tracker updates workflow status and transitions to subsequent milestones within the Directed Acyclic Graph. This real-time monitoring enables users and professionals to progress efficiently through the workflow without manual reconciliation. The automated detection of milestone completion significantly reduces administrative overhead and increases operational reliability.

The invention's structured and automated approach to workflow execution enhances procedural determinism by ensuring that every milestone advances in accordance with its preconditions and dependencies. Because the Milestone Directed Acyclic Graph Compiler enforces a Directed Acyclic Graph format, the system prevents cyclical or ambiguous transitions that could otherwise disrupt workflow execution. This architecture enables scalable workflows that can span simple tasks or complex multi-domain procedures. The deterministic nature of the Directed Acyclic Graph makes the system well-suited for regulated environments where precision is essential. Thus, procedural consistency becomes a built-in feature rather than a manually enforced constraint.

The invention provides additional adaptability through dynamic recompilation capabilities within the Milestone Directed Acyclic Graph Compiler. When the Runtime Workflow Tracker identifies a verified event that meaningfully alters subsequent workflow conditions, the Directed Acyclic Graph can be recompiled to reflect updated task sequences or preconditions. Similarly, if the governing context determined by the Context Resolver changes based on newly supplied information, the milestone structure can adjust accordingly. This dynamic adaptability enables workflows to evolve in real time without sacrificing consistency. As a result, the system remains resilient in the face of changing circumstances.

The Natural-Language Processing Engine, Hierarchical Tag Graph, and Context Resolver collectively provide the foundation for multi-domain applicability, allowing the invention to operate across industries such as legal services, construction, healthcare, education, and finance. Each domain benefits from the system's ability to translate unstructured natural-language content into structured milestones governed by appropriate contextual rules. The Hierarchical Tag Graph allows each domain to maintain its own taxonomy of rules, required documents, and procedural relationships. Meanwhile, the Context Resolver ensures compliance with local regulations or institutional frameworks. This holistic design allows the system to scale across virtually any rule-governed service domain.

The invention also incorporates logic to automatically generate self-action workflows when the milestone structure contains only client action items and lacks professional action items. In these scenarios, the system identifies that no professional intervention is required and therefore generates a workflow designed for user self-execution. The Runtime Workflow Tracker continues to monitor verified events within these workflows, enabling users to complete tasks independently while maintaining procedural accuracy. This functionality reduces unnecessary professional involvement in simple cases. It also expands access to procedural guidance for users who prefer or require an autonomous path.

In certain situations where the milestone structure contains no professional action items and no formal engagement agreement is required, the system may generate a community-forum output. This output allows users to share their workflow or solicit feedback from peers or community members. The community-forum output ensures that straightforward matters are routed to an appropriate support environment without unnecessarily burdening professionals or triggering contractual processes. This routing mechanism enhances efficiency within the broader service ecosystem. Thus, the invention supports tiered service pathways based on complexity.

The invention further includes functionality for generating audit-log entries for each verified event automatically during workflow execution. Each audit-log entry contains a timestamp, a role identifier, and an event identifier, creating a comprehensive record of workflow history. These audit-log entries support transparency, accountability, and regulatory compliance across multi-domain workflows. The auditing capabilities also provide important evidentiary and quality-assurance functions when workflows must be reviewed. As a result, the system ensures that every workflow is accompanied by a verifiable and tamper-resistant event record.

The use of consistent terminology across system components—such as the Natural-Language Processing Engine, Hierarchical Tag Graph, Context Resolver, Milestone Directed Acyclic Graph Compiler, Cost Binder, Engagement Generator, and Runtime Workflow Tracker—ensures that the invention meets the clarity requirements of 35 U.S.C. § 112(b). By maintaining strict consistency in how each term is used within the system and across all claims, the invention minimizes ambiguity and enhances the precision with which each element is understood. The system's structure also mitigates the risk of unintended means-plus-function interpretations under § 112(f). This clarity improves examination efficiency and strengthens the overall patentability of the invention. Thus, consistent terminology is both a functional and legal advantage.

Overall, the invention solves the long-standing problem of translating unstructured natural-language inputs into structured, executable workflows by integrating multiple specialized components that work together cohesively. The Natural-Language Processing Engine interprets natural-language content, the Hierarchical Tag Graph categorizes it, and the Context Resolver ensures that the appropriate governing context is applied. The Milestone Directed Acyclic Graph Compiler then creates a logically structured and procedurally correct workflow, while the Cost Binder and Engagement Generator convert this workflow into an enforceable agreement. The Runtime Workflow Tracker executes and monitors the workflow. Together, these components form a unified Script-to-Workflow Compiler capable of automating complex procedural processes across numerous professional domains.

The invention represents a significant advancement over traditional workflow systems, which do not provide automated interpretation, classification, contextualization, cost structuring, contractual generation, and verified execution in a single integrated platform. By ensuring that every workflow step is grounded in a milestone structure with preconditions, actions, and verified events, the invention creates a predictable and accountable execution environment. Furthermore, the system's ability to dynamically adapt to new information ensures resilience and relevance throughout the entire workflow lifecycle. The inclusion of structured cost objects and variance limiters improves financial predictability. As a result, the invention delivers efficiency, clarity, and consistency across diverse workflows.

The invention's architecture is inherently extensible and capable of incorporating additional domain rules, professional roles, or workflow constraints without requiring significant modification to core system components. The Hierarchical Tag Graph provides a flexible framework for adding or refining domain classifications, while the Context Resolver adapts easily to new regulatory conditions. The Milestone Directed Acyclic Graph Compiler and Runtime Workflow Tracker naturally accommodate expanded workflow sequences. Similarly, the Cost Binder and Engagement Generator can incorporate new cost structures or contractual models as needed. This extensible architecture ensures long-term applicability as domains evolve.

In summary, the invention provides a comprehensive, automated mechanism for generating, executing, and monitoring multi-domain workflows derived from natural-language script inputs. The coordinated operation of the Natural-Language Processing Engine, Hierarchical Tag Graph, Context Resolver, Milestone Directed Acyclic Graph Compiler, Cost Binder, Engagement Generator, and Runtime Workflow Tracker results in a structured, verifiable, and context-sensitive workflow. Each workflow is grounded in a milestone structure comprising preconditions, client action items, professional action items, verified events, and structured cost objects. The system also supports adaptive questioning, dynamic recompilation, and self-action workflows when professional support is unnecessary. Collectively, these features produce a robust, scalable, and highly automated Script-to-Workflow Compiler suitable for a broad range of professional service applications.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates an example block diagram of the computing system and application program including modules, engines, layers, and data structures, according to some embodiments;

FIG. 3 illustrates a flowchart showing an example method for transforming a script input into an executable workflow, according to some embodiments;

FIG. 4 illustrates a flowchart showing an example process for capturing, validating, normalizing, and forwarding a script input for semantic analysis, according to some embodiments;

FIG. 5 illustrates a flowchart showing an example process performed by the natural-language processing engine to extract entities, intents, time references, and obligations, according to some embodiments;

FIG. 6 illustrates a flowchart showing an example process performed by the hierarchical tag graph module to classify a script input into a primary domain tag and a sub-domain tag, according to some embodiments;

FIG. 7 illustrates a flowchart showing an example process performed by the context resolver to determine a governing context applicable to a script input, according to some embodiments;

FIG. 8 illustrates a flowchart showing an example process performed by the milestone directed acyclic graph compiler to generate a milestone structure, according to some embodiments;

FIG. 9 illustrates a flowchart showing an example process for updating a milestone structure in response to new information or verified events, according to some embodiments;

FIG. 10 illustrates a flowchart showing an example process performed by the cost binder to generate structured cost objects for milestones, according to some embodiments;

FIG. 11 illustrates a flowchart showing an example process performed by the engagement generator to assemble an engagement agreement, according to some embodiments;

FIG. 12 illustrates a flowchart showing an example process executed by the runtime workflow tracker to monitor milestones and advance workflow execution, according to some embodiments;

FIG. 13 illustrates a flowchart showing an example process for generating audit-log entries to record workflow events and system actions, according to some embodiments;

FIG. 14 illustrates a flowchart showing a system-wide data transformation pipeline through which a script input is converted into an executed workflow, according to some embodiments;

FIG. 15 illustrates a flowchart showing an example multi-module interaction sequence demonstrating how structured data is transferred across modules and layers, according to some embodiments;

FIG. 16 illustrates a flowchart showing an example lifecycle of system-generated data structures from raw input to executed workflow states, according to some embodiments; and

FIG. 17 illustrates a flowchart showing an example dynamic recompilation process for updating a Directed Acyclic Graph based on new information or verified events, according to some embodiments.

### DETAILED DESCRIPTION OF THE INVENTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The present invention is a software system designed to seamlessly transform client-provided input into structured case milestones for generating personalized quotes and contracts for legal services and case management module with client-facing and attorney-facing interfaces. The computerized process separate cases with low suitability for attorney intervention and transforms complex legal cases into manageable actionable components grouped by client items and attorney items. The software features client-facing and attorney-facing interfaces, both connected to a centralized database that stores user (client and attorney) profiles, case data, legal categories, and case management data.

The systems and methods described herein may be implemented across a wide variety of domains, and the underlying architecture is not limited to any specific professional field. The platform may receive a script input describing matters that arise in legal, medical, construction, educational, financial, consulting, or administrative contexts, and the same processing pipeline may be applied regardless of subject matter. The natural-language processing engine, classification engine, context resolver, workflow generation components, cost engines, scoring engines, routing components, and workflow execution components may operate using domain-agnostic data structures that allow extracted entities, intents, obligations, or time references to be interpreted consistently across multiple industries. The system may generate milestone structures, structured cost objects, and engagement agreements based on workflows that differ by domain, yet rely on a common computational framework. This domain-agnostic approach allows the platform to support flexible rule sets, adaptive classification models, and variable workflow templates that can be updated or extended without altering the underlying system architecture.

Utilizing Natural Language Processing, the system categorizes client cases with Level 1 tag (main legal category) and Level 2 tag (subcategory), identifies applicable laws and standards of proof, extracts relevant facts and documents, and assigns prioritization scores based on legal significance, complexity, and likelihood of success. By organizing the information in this way, the system can evaluate the “attorney suitability score” (i.e., suitability for attorney intervention) of large amounts of cases and determine the appropriate course of action for each case: community forum, client self-action, or attorney engagement.

The system provides clients with a user-friendly input interface, where they can describe their issues in natural language without lengthy questionnaires or daunting intake process. Clients can choose whether to seek community forum feedback or a legal solution with self-action or attorney engagement. For cases with low suitability for attorney intervention (e.g., non-legal, low potential reward, or potential class matters), the system may recommend the community forum. For cases requiring legal solution or assistance, the software generates tailored suggestions for client action items, attorney action items, deadlines, dates, costs, and payment terms (referred to as “case milestones”). The system may suggest that clients take self-action (according to the generated client action items) or forward the client case (with the generated client and attorney action items) to attorneys for review.

Attorneys receive client case leads based on their Level 1 specialization selected during their signup process. Using an integrated communication tool (messaging, voice and video call), attorneys can ask clients questions and customize the case milestones according to the client's specific needs before submitting a fixed-price quote for client review. Clients can negotiate quotes, view attorneys' professional profiles, select the attorney with their preferred case milestones, costs, and payment terms, sign a system-generated customized contract for legal services, and manage the case milestones through a unified platform. The platform offers milestone tracking, document management, secure communication, and payment processing.

In general, the embodiments provided herein relate to a system to transform a script input containing natural-language text, voice-to-text content, or document information into a structured workflow using coordinated computational components that analyze, classify, contextualize, and process the input. The system may employ a Natural-Language Processing Engine to extract entities, intents, time references, and obligations, and may use a Hierarchical Tag Graph to classify the extracted information into a primary domain tag and a sub-domain tag. A Context Resolver may determine a governing context for the script input, which may then be used by a Milestone Directed Acyclic Graph Compiler to generate a milestone structure comprising milestones with preconditions, client action items or professional action items, and verified events. A Cost Binder may assign a structured cost object to each milestone and apply a variance limiter, while an Engagement Generator may produce an engagement agreement referencing the milestone structure and the structured cost objects. A Runtime Workflow Tracker may execute the milestone structure by detecting verified events, updating workflow progression, and enabling automated workflow execution across a variety of professional and regulated domains.

The system may be implemented using one or more processors and one or more memory devices configured to execute stored instructions that collectively transform a script input into an executable workflow. The script input may include natural-language text, voice-to-text content, or document information provided by a user through a user interface. The system may operate in a distributed or single-machine architecture, and the underlying software may be executed within a server environment, a cloud-computing environment, or a hybrid deployment. Each computing component may communicate using secure network protocols to transmit data necessary for workflow generation and execution. The overall arrangement of modules may allow an input narrative to be received, analyzed, classified, contextualized, converted into structured milestones, assigned cost attributes, compiled into an engagement agreement, and monitored during execution.

A Natural-Language Processing Engine may be used to analyze the script input and produce a structured representation of its content. The Natural-Language Processing Engine may perform text tokenization, entity extraction, intent classification, semantic parsing, syntactic evaluation, or contextual embedding generation. These operations may be executed using rule-based techniques, statistical models, neural networks, or hybrid approaches, allowing the Natural-Language Processing Engine to interpret natural-language expressions with flexibility. The Natural-Language Processing Engine may also evaluate time references and obligations expressed in the script input, such as deadlines, requirements, or stated goals. The structured representation generated by the Natural-Language Processing Engine may then be used to support downstream classification and workflow creation.

The system may include a Hierarchical Tag Graph that provides a structured taxonomy of domain categories and sub-domain categories. The Hierarchical Tag Graph may be stored as a graph data structure with nodes representing primary domain tags and sub-domain tags, and edges representing hierarchical relationships. Each node may include metadata describing required documents, responsible roles, governing rules, or time-and-cost parameters associated with that domain or sub-domain. The system may map extracted entities and intents from the Natural-Language Processing Engine to specific nodes within the Hierarchical Tag Graph to determine how the script input should be categorized. This mapping may be used to ensure that later workflow components are generated in accordance with accurate domain classifications.

A Context Resolver may determine the governing context applicable to the script input. The Context Resolver may evaluate geographic indicators, regulatory indicators, device-based geolocation, user-input jurisdiction selections, or contextual references extracted from the Natural-Language Processing Engine. The Context Resolver may incorporate weighted inference models, rule-based evaluation, or ensemble logic to determine which jurisdictional or contextual regime applies. The governing context may affect which rules, standards, or document requirements are relevant to the workflow. The Context Resolver may output a discrete governing context representation that is used throughout subsequent workflow generation tasks.

A Milestone Directed Acyclic Graph Compiler may be configured to generate a milestone structure that includes a plurality of milestones derived from the primary domain tag, the sub-domain tag, and the governing context. The Milestone Directed Acyclic Graph Compiler may determine a logical sequence of milestones by establishing dependency relationships and ordering constraints based on metadata stored in the Hierarchical Tag Graph and the governing context. Each milestone may include at least one precondition that must be satisfied before the milestone can be completed, at least one action that may include a client action item or a professional action item, and at least one verified event marking milestone completion. The Milestone Directed Acyclic Graph Compiler may ensure that the milestone structure forms a Directed Acyclic Graph without cyclical dependencies. This Directed Acyclic Graph may serve as the basis for deterministic workflow execution.

Preconditions within each milestone may define factual, procedural, or documentary requirements that the user or a professional may need to satisfy. Preconditions may include expected documents, factual confirmations, approvals, or other criteria determined by the primary domain tag and the governing context. When a precondition is missing, the system may request additional input using follow-up questions produced by the Natural-Language Processing Engine. This dynamic precondition evaluation may refine the accuracy of milestone activation and sequencing. Preconditions may also incorporate rules specific to jurisdictional requirements, time-sensitive tasks, or dependency constraints found within the Directed Acyclic Graph.

Actions within milestones may represent tasks assigned to a user or to a professional, depending on the classification of the milestone. A client action item may include user-executable tasks such as answering a questionnaire, uploading a document, signing a document, or completing a form. A professional action item may include tasks requiring domain expertise, such as drafting a document, reviewing a file, conducting research, preparing a filing, performing an inspection, or providing specialized consultation. The system may specify which actor is responsible for each action based on metadata within the Hierarchical Tag Graph and the governing context. This assignment allows the workflow to allocate tasks according to skill, expertise, and regulatory compliance parameters.

A verified event may represent an objective indication that a milestone has been completed. Verified events may include timestamped document uploads, digital signatures, confirmations received through authenticated APIs, or other machine-verifiable records. The system may evaluate verified events using hashing techniques, logging procedures, or third-party verification mechanisms, depending on the governing context. Verified events may be recorded in an audit-log entry that includes a timestamp, a role identifier, and an event identifier. The verified event may serve as the trigger for the Runtime Workflow Tracker to progress to the next milestone in the Directed Acyclic Graph.

A Cost Binder may assign a structured cost object to each milestone. The structured cost object may include fields describing time estimates, service fees, material costs, or other parameters relevant to the action items and preconditions associated with the milestone. The Cost Binder may apply a variance limiter that constrains the allowable cost deviation to maintain predictable pricing. The structured cost object may be dynamically adjusted if the governing context or milestone structure changes. These adjustments may be logged and incorporated into updated workflow displays or engagement agreements.

The Engagement Generator may convert the milestone structure and the structured cost objects into an engagement agreement formatted for electronic signature. The engagement agreement may include contractual terms referencing each milestone, each structured cost object, and the workflow's preconditions, actions, and verified events. The Engagement Generator may generate human-readable documents, machine-readable data representations, or hybrid formats depending on system configuration. The agreement may be stored in a document management system or transmitted to a user for execution. When executed, the engagement agreement may provide the contractual basis for workflow execution.

A Runtime Workflow Tracker may manage the execution of the milestone structure. The Runtime Workflow Tracker may monitor milestones to detect when verified events indicate completion. It may update workflow status, trigger subsequent milestones within the Directed Acyclic Graph, and initiate payment or notification events where applicable. The Runtime Workflow Tracker may operate in real time or near real time, depending on system configuration. It may also coordinate with logging systems to maintain audit integrity.

The system may generate dynamic follow-up questions to collect additional information required to satisfy unmet preconditions. These follow-up questions may be produced by the Natural-Language Processing Engine using rule-based or model-driven techniques that analyze gaps between the script input and milestone requirements. This dynamic questioning process may reduce unnecessary user burden by focusing only on missing information rather than presenting large questionnaires. As new information is submitted, the milestone structure may update accordingly. This approach may support iterative refinement of workflow accuracy.

The Directed Acyclic Graph produced by the Milestone Directed Acyclic Graph Compiler may support recompilation when workflow conditions change. For example, completion of a verified event may introduce new dependency relationships or remove obsolete requirements, prompting the Directed Acyclic Graph to rebuild certain branches. Similarly, changes to the governing context may require adjustments to milestone ordering, preconditions, or required documents. The Directed Acyclic Graph may be maintained in memory as an updatable structure capable of evolving with user-provided data. This flexibility may support continuous accuracy throughout workflow execution.

A self-action mode may be generated when the milestone structure lacks professional action items. Under this mode, the system may determine that the user can complete the milestone structure independently. The Runtime Workflow Tracker may still monitor verified events and update workflow progression, ensuring that the Directed Acyclic Graph processes tasks correctly. The system may present instructions or templates to assist the user in completing each client action item. This pathway may help users resolve simple matters without external professional involvement.

A community-forum output may be generated when the milestone structure contains no professional action items, and no engagement agreement is required. In this mode, the system may generate content representing the workflow or a summary of potential actions. Users may share this output with a community environment to obtain additional insight or non-professional feedback. The Context Resolver may still determine the governing context for such content to ensure relevance. This mode may serve as a low-complexity pathway for user-directed problem-solving.

Audit-log entries generated during workflow execution may be stored within a secure logging system. Each audit-log entry may include a timestamp, a role identifier, and an event identifier to maintain an accurate record of workflow activity. The system may employ cryptographic hashing or chaining methods to preserve the integrity of logged entries. Audit logs may be used for recordkeeping, compliance verification, or post-execution review. The logs may be retrieved or exported through administrative interfaces.

To support multi-domain use, the Hierarchical Tag Graph may include domain-specific hierarchies across legal, medical, construction, educational, financial, or administrative workflows. Each domain may define its own metadata associated with milestones, structured cost objects, and verified events. The Context Resolver may evaluate the governing context for these domain-specific workflows, ensuring that correct rules and procedures apply. The Natural-Language Processing Engine may interpret natural-language input for each domain using domain-specific linguistic patterns. These capabilities may support broad applicability across diverse fields.

The memory devices used by the system may store the instructions for all modules and may also store domain models, structured taxonomies, logs, structured cost objects, and user inputs. The processors may execute instructions in parallel or sequentially depending on system configuration. Communication channels between components may use secure protocols, including encryption or authentication mechanisms, to maintain data confidentiality. The system may operate on commodity hardware or specialized computing environments. These configurations may enable deployment flexibility.

The system architecture may provide interoperability with external services where professional action items or verified events rely on third-party APIs. Examples may include electronic signature services, governmental document submission portals, identity-verification services, or payment-processing gateways. The Context Resolver may use external APIs to determine geographic or regulatory attributes. Verified events may integrate with third-party validation systems to confirm milestone completion. These integrations may expand system functionality beyond internal components.

Collectively, the components described above may be configured to interact in a coordinated sequence to transform the script input into a structured, executable workflow represented by a Directed Acyclic Graph. The Natural-Language Processing Engine, Hierarchical Tag Graph, Context Resolver, Milestone Directed Acyclic Graph Compiler, Cost Binder, Engagement Generator, and Runtime Workflow Tracker may each provide distinct computational contributions to this transformation. Each module may be implemented as dedicated software, microservices, or combined subsystems. The interactions among these modules may enable consistent and repeatable workflow generation. These technical details may enable system implementation by a practitioner with undergraduate-level software engineering knowledge and domain experience.

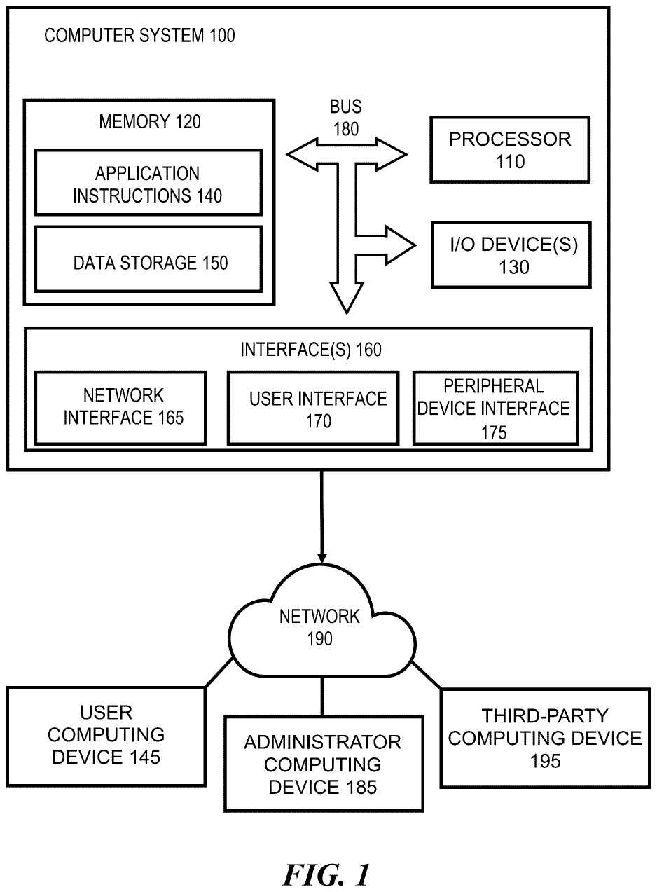

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

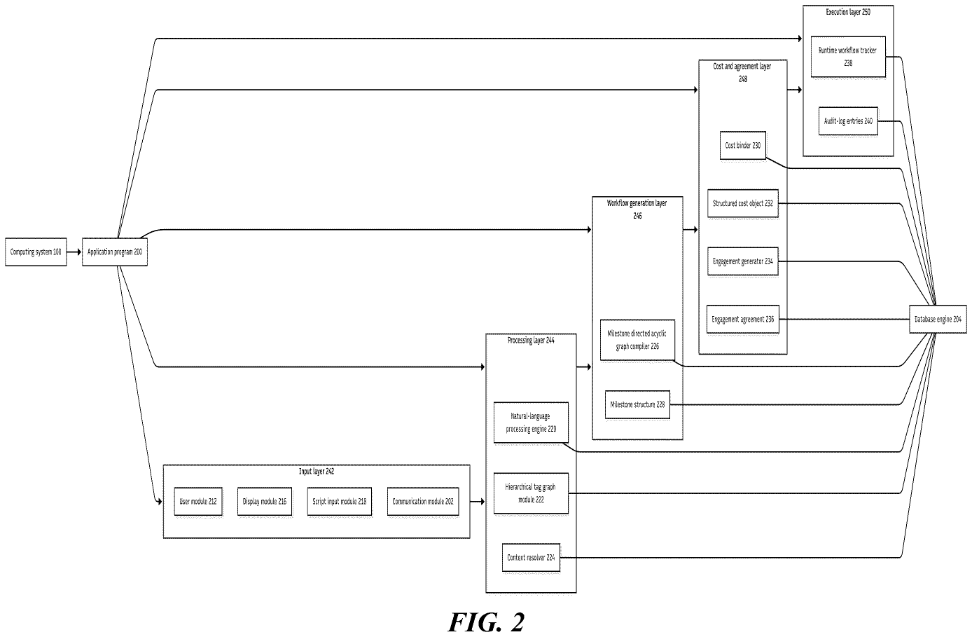

Referring to FIG. 2, the computing system 100 may include an application program 200 that organizes its functionality into multiple layers. These layers may include an input layer 242, a processing layer 244, a workflow generation layer 246, a cost and agreement layer 248, and an execution layer 250. Each layer may contain modules or engines that perform specific functions and may communicate with modules in other layers as workflow logic propagates from initial script input toward final workflow execution. This layered system architecture may allow the application program 200 to manage domain classification, contextual analysis, workflow generation, financial structuring, agreement formation, and execution tracking in a coordinated sequence. The following sections describe each module and engine included in FIG. 2 in connection with its corresponding layer.

The input layer 242 may serve as the entry point for all user-submitted information, including natural-language content, voice-to-text data, and document uploads. This layer may combine graphical interface components, user-access features, and data capture modules that ensure all script inputs are formatted and delivered for downstream processing. The input layer 242 may interact with the processing layer 244 to initiate semantic extraction using the natural-language processing engine 220. It may also notify the workflow generation layer 246 when new input becomes available that may influence milestone creation or modification. The input layer 242 may therefore act as the foundation of the workflow pipeline.

The user module 212 may authenticate users, assign roles, and manage permissions across the system. It may maintain user profiles describing whether a user is a client user, a professional user, or an administrative user, and may determine which modules or interface components each user may access. The user module 212 may use secure login procedures, session tokens, and encrypted verification processes to maintain the integrity of user access. It may also track user selections, workflow participation, and interactions with interface components, such as document uploads or milestone acknowledgments.

In addition to role-based access control, the user module 212 may manage user preferences and configuration settings that control how content is displayed in the display module 216. The module may interface with the communication module 202 to deliver system alerts, workflow updates, and milestone reminders. The user module 212 may also provide the processing layer 244 with user metadata relevant to contextual or domain classification, such as location settings or stated professional credentials. These interconnections may ensure consistent personalization and proper workflow segmentation.

The display module 216 may generate visual interfaces used by client users, professional users, and administrative users to interact with the system. It may present graphical elements including script input panels, milestone views, structured cost object displays, workflow progress indicators, and document review windows. In some embodiments, the display module 216 may dynamically update interface content based on real-time output from the runtime workflow tracker 238. The module may additionally manage navigation structures that direct users through workflow steps and action items.

The display module 216 may support multiple device formats including desktop, tablet, and mobile screens, and may incorporate accessibility features such as scalable text, screen reader compatibility, and high-contrast modes. It may also integrate with the communication module 202 to present real-time chat, notifications, or system messages. The display module 216 may further interact with the engagement generator 234 to present engagement agreements in formats suitable for electronic signature. Through these capabilities, the display module 216 may provide a cohesive user experience throughout workflow creation and execution.

The script input module 218 may receive natural-language text, voice-to-text input, or document information submitted by a user. It may preprocess this content by removing formatting artifacts, converting voice recordings into text, and extracting readable text from uploaded documents. The script input module 218 may validate input completeness and consistency before transferring the script input to the natural-language processing engine 220. This preprocessing may improve the accuracy of subsequent entity extraction and domain classification.

The script input module 218 may also detect when a user has provided multiple input types simultaneously, such as text descriptions accompanied by uploaded files, and may appropriately package these materials for analysis. The module may further maintain metadata describing the time of upload, file characteristics, and user identifiers, enabling accurate mapping of script inputs to workflow events. In certain implementations, the module may support multilingual content and may initiate translation pipelines when required. These functions may ensure that the processing layer 244 receives clean, structured input.

The processing layer 244 may analyze the script input and generate the semantic and contextual data structures that drive workflow generation. This layer may include the natural-language processing engine 220, the hierarchical tag graph module 222, and the context resolver 224. Each component may operate sequentially or in parallel depending on system configuration. The processing layer 244 may produce structured representations of content, domain classifications, and governing contexts used directly by the workflow generation layer 246. Through this pipeline, raw user submissions may be converted into actionable procedural data.

The natural-language processing engine 220 may extract entities, intents, time references, and obligations from the script input using rule-based, statistical, or neural-network-based techniques. It may structure these extracted features into labeled objects representing events, participants, deadlines, or user-specified objectives. The natural-language processing engine 220 may also detect ambiguous or incomplete information, triggering generation of follow-up questions aimed at resolving unmet preconditions relevant to milestone creation. This dynamic question-generation capability may reduce unnecessary requests by focusing only on relevant missing data.

The engine may interact closely with the hierarchical tag graph module 222 by providing tagged entities and semantic indicators used for domain classification. It may also coordinate with the context resolver 224 by identifying jurisdictional or regulatory terms embedded within the script input. Additionally, the natural-language processing engine 220 may log intermediate extraction states for audit purposes or for use in model refinement. These interrelations may enable robust semantic interpretation and accurate representation of user submissions.

The hierarchical tag graph module 222 may classify the structured representation of the script input into a primary domain tag and a sub-domain tag. It may maintain a Hierarchical Tag Graph comprising nodes representing domain categories and sub-domain categories, each node containing metadata describing governing rules, required documents, or procedural relationships. When supplied with extracted entities and intents, the hierarchical tag graph module 222 may select relevant nodes by evaluating metadata alignment, semantic similarity, or rule-based mapping criteria. This classification may ensure that workflow generation aligns with domain-specific expectations.

The module may allow for modifications to the Hierarchical Tag Graph, such as adding new domain categories or refining domain relationships as the platform evolves. It may interact with the context resolver 224 to validate that the primary domain tag and sub-domain tag align properly with the governing context. In some implementations, the module may weight multiple domain candidates and output confidence scores representing classification certainty. This classification process may be foundational for workflow generation.

The context resolver 224 may determine the governing context associated with the script input by evaluating geographic indicators, regulatory indicators, or contextual references from the natural-language processing engine 220. It may incorporate weighted inference models, rule-based evaluation, or hybrid approaches to assess contextual cues such as location references, jurisdictional markers, or relevant regulatory language. The output governing context may include region-specific rules, document types, or procedural requirements.

The context resolver 224 may interact with the hierarchical tag graph module 222 to ensure that domain classification and governing context assignments do not conflict. It may also adjust governing context outputs when additional script input or follow-up question responses provide new contextual clues. This ability to refine contextual understanding may support accurate generation of milestone structures. The context resolver 224 may store or retrieve contextual metadata using the database engine 204.

The workflow generation layer 246 may convert classified and contextualized data into a milestone structure capable of driving procedural execution. This layer may include the milestone directed acyclic graph compiler 226 and the milestone structure 228. It may produce workflow sequences that incorporate domain rules, contextual constraints, and logical dependencies between tasks. The output of this layer may determine the entire structure of execution carried out by the execution layer 250. Through this layer, the system may transform semantic understanding into actionable steps.

In some embodiments, a workflow structure is implemented as a milestone structure 228 organized as a Directed Acyclic Graph, while in other embodiments the workflow structure may use alternative representations such as conditional task sequences, rule-based engines, or state machines.

The milestone directed acyclic graph compiler 226 may generate a Directed Acyclic Graph (DAG) that represents workflow milestones and their dependencies. It may use the primary domain tag, sub-domain tag, and governing context to determine appropriate tasks, expected actions, and procedural sequences. Each milestone generated may include preconditions, client action items or professional action items, and verified events that govern milestone completion. The compiler may ensure that no cycles exist in the DAG, supporting deterministic workflow progression.

The compiler may further evaluate alternative workflow paths, parallelizable branches, or conditional dependencies tied to user responses or verified events. If new information becomes available from follow-up questions or additional script inputs, the compiler may regenerate parts of the DAG to reflect updated requirements. It may also log these structural changes for audit purposes. The milestone directed acyclic graph compiler 226 may therefore coordinate closely with both the processing layer 244 and execution layer 250.

The milestone structure 228 may contain all milestones produced by the milestone directed acyclic graph compiler 226, including their metadata, dependencies, and completion criteria. Each milestone may be represented as an object containing descriptive fields, preconditions, action items, verified events, and relevant cost associations. These objects may be stored in graph form or serialized formats for efficient retrieval.

The milestone structure 228 may update dynamically when verified events are detected or when governing context changes occur. It may also maintain version histories to support rollback functionality and review of historical workflow states. In addition, the milestone structure 228 may provide data directly to the engagement generator 234 and runtime workflow tracker 238. This structure may thus serve as the central procedural blueprint for workflow execution.

The cost and agreement layer 248 may integrate pricing logic, cost modeling, agreement formation, and contract execution into a unified framework. This layer may include the cost binder 230, the structured cost object 232, the engagement generator 234, and the engagement agreement 236. The layer may be used by administrators, professionals, and users to review, validate, and execute financial and contractual aspects of the workflow. The cost and agreement layer 248 may rely heavily on data produced by the workflow generation layer 246.

The cost binder 230 may assign structured cost objects 232 to each milestone within the milestone structure 228. It may consider factors such as estimated time, resource consumption, professional fees, or material requirements. The cost binder 230 may use a variance limiter to restrict fluctuations in cost estimates and maintain predictable pricing. These limitations may use predefined tolerances or heuristic adjustments based on domain rules.

The cost binder 230 may interact with the database engine 204 to retrieve historical costs or update stored pricing templates. It may also communicate with the engagement generator 234 to populate cost fields in engagement agreements. In dynamic workflows, the cost binder 230 may adjust costs when milestone structures or governing contexts evolve. These interactions may ensure consistency across financial modeling and procedural outputs.

The structured cost object 232 may represent the pricing details associated with each milestone. It may include fields for time estimates, service fees, material costs, or jurisdictional surcharge values. These objects may be created during initial workflow generation and updated as workflows evolve.

The structured cost object 232 may be stored in data records accessible to the engagement generator 234 and runtime workflow tracker 238. It may support serialization and transmission to ensure interoperability with external billing or payment systems. The object may also contribute to invoice generation and cost forecasting tools used within the system.

The engagement generator 234 may produce an engagement agreement 236 that includes milestones, structured cost objects, preconditions, actions, and verified events. It may use template logic, structured fields, and contextual rules to assemble a coherent set of contractual terms. The engagement generator 234 may also prepare the engagement agreement 236 for electronic signature by integrating with digital signature APIs or identity verification services.

In some implementations, the engagement generator 234 may produce amendments or supplementary agreements when milestone structures or cost objects update. It may archive all executed agreements using the database engine 204 and may present agreements to users through the display module 216. These capabilities may support legally compliant contracting across domains.

The engagement agreement 236 may define workflow obligations, procedural requirements, structured cost objects, and payment schedules. It may reference each milestone within the milestone structure 228 and articulate the responsibilities of users or professionals. The engagement agreement 236 may be presented in a human-readable format suitable for electronic execution.

Once executed, the engagement agreement 236 may bind the workflow logic managed by the runtime workflow tracker 238. It may be stored securely and retrieved for audit, compliance, or review purposes. Updates to cost or milestone structures may trigger new agreements or attached riders.

The execution layer 250 may supervise the operational execution of workflows. This layer may include the runtime workflow tracker 238 and audit-log entries 240. It may advance workflows based on verified events and maintain a record of workflow execution for compliance and review. The execution layer 250 may interact with input, processing, generation, and financial components as workflows progress.

The runtime workflow tracker 238 may detect verified events, evaluate milestone completion, and advance workflows according to the Directed Acyclic Graph produced by the milestone directed acyclic graph compiler 226. It may monitor user actions, professional submissions, digital signatures, and external confirmations. When a milestone completes, the runtime workflow tracker 238 may activate downstream milestones and notify users accordingly.

The runtime workflow tracker 238 may also initiate billing events, scheduling prompts, or status notifications. It may maintain internal state machines that track milestone activation and completion conditions. Integration with the audit-log entries 240 may ensure full transparency into workflow activity.

Audit-log entries 240 may serve as system-generated records describing verified events, milestone completions, user interactions, timestamps, and role identifiers. These logs may be stored securely using the database engine 204 and may support regulatory or administrative review. Each log entry may be hashed or linked to preceding entries to prevent tampering.

Audit-log entries 240 may be retrieved for inspection using administrative tools or exported for compliance reporting. They may also support diagnostics or dispute clarification when reviewing workflow execution history. These logs may be generated automatically as workflows progress through the runtime workflow tracker 238.

In some embodiments, the application program 200 includes a scoring engine 252 configured to compute one or more quantitative scoring metrics derived from extracted semantic features, domain classifications, governing context information, milestone definitions, and workflow metadata. The scoring engine 252 may operate within the processing layer 244 or within an adjacent layer depending on system configuration, and it may be executed by one or more processors using rule-based scoring logic, machine-learning scoring logic, or hybrid scoring models stored in memory. The scoring engine 252 may receive as input extracted entity objects generated by the natural-language processing engine 220, classification objects generated by the hierarchical tag graph module 222, and governing context objects generated by the context resolver 224. These inputs may be combined with milestone structure information produced by the milestone directed acyclic graph compiler 226 and structured cost objects 232 generated by the cost binder 230. The scoring engine 252 may store intermediate scoring variables and final computed score values in the database engine 204 for retrieval by other modules.

In some embodiments, the scoring engine 252 generates a case worthiness score that reflects whether the script input corresponds to facts, events, or procedural circumstances that align with a target workflow or domain. The scoring engine 252 may compute the case worthiness score using a weighted aggregation model where weighting coefficients are maintained in memory and can be configured based on professional settings or domain requirements. These factors may include severity derived from extracted obligations or detected events, complexity derived from the number of milestones or dependency depth within the Directed Acyclic Graph, evidence strength based on document completeness or corroborating entity objects, time sensitivity derived from statutory deadlines or temporal references, and outcome likelihood based on historically observed workflow patterns. The scoring engine 252 may produce the case worthiness score as a numerical value or a categorical label. The runtime workflow tracker 238 or the user module 212 may use this score to determine whether additional preconditions should be requested or whether workflow advancement should be deferred.

In some embodiments, the scoring engine 252 computes a client readiness score that reflects how prepared a client participant is to proceed through the milestone structure. The scoring engine 252 may evaluate completeness and quality of responses provided to follow-up questions generated by the natural-language processing engine 220 or context resolver 224. It may also evaluate whether required documents have been submitted, whether required acknowledgments have been received, or whether the user has satisfied milestone preconditions. The scoring engine 252 may modify the client readiness score dynamically as the runtime workflow tracker 238 detects verified events such as document uploads or milestone approvals. Additional factors may include prior client responsiveness, history of missed deadlines or abandoned workflows, jurisdictional fit, and conflict check results stored in memory. The client readiness score may be shared with the display module 216 to inform participants of their readiness level or required next steps.

In some embodiments, the scoring engine 252 computes a professional suitability score intended to match a workflow or matter with an appropriate professional participant. The scoring engine 252 may retrieve stored professional profile objects from the database engine 204 that include licensing jurisdictions, specialization tags, historical performance indicators, workload availability, communication responsiveness, and compliance indicators. The scoring engine 252 may also compare structured cost objects 232 to professional pricing models to determine cost alignment or suitability. These factors may be aggregated into a numerical or categorical professional suitability score that may influence routing decisions or professional assignment. The engagement generator 234 may reference the professional suitability score when selecting engagement terms or when determining whether a matter requires professional review.

In some embodiments, the scoring engine 252 may normalize each scoring metric to a common numerical scale and may assign categorical labels such as auto engage, requires review, self action only, or cohort eligible. Normalized scoring objects may be stored in the database engine 204 as structured scoring objects linked to corresponding entries within the milestone structure 228. The system may provide these scoring objects to the routing component or workflow generation layer 246 to determine whether a workflow requires professional oversight, client self action, or additional information gathering. The scoring engine 252 may also provide updated scoring objects to the milestone directed acyclic graph compiler 226 during dynamic Directed Acyclic Graph recompilation triggered by new verified events.

In further embodiments, the scoring engine 252 may trigger workflow branching decisions based on one or more computed scoring values. If thresholds for case worthiness, client readiness, or professional suitability fall within predefined ranges, the routing logic may determine whether to initiate a professional managed workflow, a client self action workflow, a collaborative cohort workflow, or a deferred or terminated workflow. The scoring engine 252 may also initiate requests for additional information or missing preconditions when scoring confidence values fall below acceptable ranges. Updates to scoring objects may prompt adjustments to structured cost objects 232 or modifications to the Directed Acyclic Graph to reflect revised procedural requirements. These dynamic scoring interactions allow the scoring engine 252 to support adaptive workflow management across multiple layers of the application program 200.

In some embodiments, the application program 200 includes a dynamic billing engine 254 configured to generate billing values that change based on workflow progress, milestone updates, or verified events detected during runtime execution. The dynamic billing engine 254 may receive structured cost objects generated by the cost binder 230, milestone updates from the milestone directed acyclic graph compiler 226, and verified event objects from the runtime workflow tracker 238. It may compute updated billing amounts using configurable rules, weighted pricing models, or usage-based calculations stored in memory. These recalculated billing values may reflect partial completion of milestones, updated preconditions, changes in complexity, or adjustments triggered by governing context or domain rules. The dynamic billing engine 254 may store updated billing entries within the database engine 204 for retrieval by the engagement generator 234 or downstream reporting components.

In some embodiments, the dynamic billing engine 254 may evaluate the effects of milestone reordering or recompilation on pricing when the Directed Acyclic Graph is updated. The engine may recalculate costs when new milestones are added, when milestones are removed, or when preconditions trigger additional documented requirements. The dynamic billing engine 254 may also compute conditional charges that depend on verified events, such as document delivery dates, user responsiveness, or task completion sequences. The engine may generate structured billing objects containing updated amounts, timestamps, variance-limiter values, and references to related milestones. These structured billing objects may support real-time price adjustments that align billing with workflow state.

In some embodiments, the dynamic billing engine 254 may integrate billing changes into engagement agreement updates. When billing changes exceed configured thresholds, the engine may trigger the engagement generator 234 to update pricing terms or issue supplemental billing notices. The dynamic billing engine 254 may also communicate with the user module 212 and display module 216 to provide real-time billing transparency. Updated billing information may be delivered to professional participants when workflow complexity increases or when additional services become necessary. These updates allow the billing logic to remain aligned with actual workflow execution.

In some embodiments, the application program 200 includes a cohort grouping and collective workflow engine 256 configured to organize multiple users into one or more coordinated cohorts. The engine may analyze extracted entity objects, domain tags, governing context objects, and scoring objects to determine whether multiple script inputs share characteristics that support collective processing. The cohort grouping and collective workflow engine 256 may identify shared milestones, overlapping obligations, common verified events, or similar procedural pathways that allow multiple users to progress as a group. The engine may generate cohort grouping objects that reference shared milestone structures and identify which users belong to each cohort. These cohort grouping objects may be stored within the database engine 204 for retrieval by the workflow generation layer 246.

In some embodiments, the cohort grouping and collective workflow engine 256 may generate collective milestone structures that extend or modify traditional milestone structures for group execution. The engine may combine or merge repeated milestones, align preconditions across multiple users, or generate shared verified events that apply collectively. When users have differing preconditions, the engine may generate subgroup requirements or assign differentiated tasks based on user eligibility or readiness. The engine may create modified Directed Acyclic Graph structures that support parallel execution across multiple participants. These collective workflows may increase efficiency for matters requiring group coordination or uniform compliance steps.

In some embodiments, the cohort grouping and collective workflow engine 256 may integrate with the runtime workflow tracker 238 to monitor progress across multiple users. Verified events associated with one cohort member may unlock shared milestones for other members when group prerequisites are satisfied. The engine may also recalculate group boundaries when new users join or when circumstances require cohort segmentation. Updated cohort structures may be propagated to the display module 216 to show collective progress. This functionality supports scalable workflows involving multiple participants with shared procedural requirements.

In some embodiments, the application program 200 includes roles, permissions, and matching modules 258 configured to establish user roles, assign access permissions, and determine role-based workflow responsibilities. These modules may receive structured role data, participant identifiers, governing context information, and extracted semantic objects. The system may define roles such as client participants, professional participants, administrative participants, reviewers, approvers, or limited-access viewers. Permissions may be defined as capabilities to view milestones, edit milestone data, complete client action items or professional action items, upload documents, or approve verified events. The roles, permissions, and matching modules 258 may generate structured permission objects and store them within the database engine 204.

In some embodiments, the roles, permissions, and matching modules 258 may evaluate user characteristics and workflow requirements to determine appropriate role assignments. These modules may utilize factors such as jurisdictional eligibility, licensing or professional registration data, scoring engine values, availability indicators, or specialization tags. The modules may generate matching decisions that pair clients with professionals or assign administrative reviewers to workflows requiring oversight. These matching results may be transmitted to the runtime workflow tracker 238 so that milestone assignments reflect participant capabilities. Updates to roles or permissions may automatically trigger updates to milestone responsibilities within the milestone structure 228.

In some embodiments, permissions may change dynamically as milestones are completed or as verified events require different forms of action. The roles, permissions, and matching modules 258 may coordinate with the display module 216 to update visible information or restrict access when milestone conditions change. These modules may also update permissions when users join or leave a workflow or when governing context changes affect role eligibility. This dynamic role management supports controlled access and protects workflow integrity across multiple participants and milestones.

In some embodiments, the application program 200 includes a milestone tracker 260 configured to monitor the real-time state of each milestone within the milestone structure 228. The milestone tracker 260 may receive milestone definitions from the milestone directed acyclic graph compiler 226 and verified event objects from the runtime workflow tracker 238. The milestone tracker 260 may evaluate preconditions, determine which milestones are ready for activation, and identify prerequisites preventing further progress. These evaluations may consider updated scoring objects, updated governing context information, and updated structured cost objects. The milestone tracker 260 may generate milestone status objects that indicate whether milestones are pending, active, completed, delayed, or blocked, and may store these status objects in the database engine 204.

In some embodiments, the milestone tracker 260 may communicate with the display module 216 to provide real-time milestone visibility to participants. The tracker may identify which action items require attention and may issue notifications or reminders through the communication module 202. When the milestone tracker 260 detects that a milestone has been completed or that a precondition is satisfied, it may notify the runtime workflow tracker 238 so that dependent milestones can be activated. The tracker may also identify missing information and request data through the script input module 218 or follow-up question logic. These operations support interactive milestone guidance throughout workflow execution.

In some embodiments, the milestone tracker 260 may evaluate performance patterns and detect deviations from expected milestone sequences. The tracker may adjust milestone order when dynamic Directed Acyclic Graph recompilation occurs as triggered by new events. It may also provide updated milestone metadata to the cost binder 230, engagement generator 234, or scoring engine 252 when changes affect cost structures, contract terms, or scoring values. These updates support coordinated milestone oversight across the workflow generation layer 246, cost and agreement layer 248, and execution layer 250. The milestone tracker 260 supports consistent workflow progression by maintaining synchronized milestone states across system modules.

In some embodiments, the system generates a workflow structure that represents procedural logic for executing one or more workflows. The workflow structure may be implemented using a milestone structure 228, a Directed Acyclic Graph, a rule-based decision engine, a state machine, a generative task sequence, a flat task list, or any other machine-readable workflow representation. The workflow structure may be stored in the database engine 204 and may be accessed by the workflow generation layer 246 and the execution layer 250. In some embodiments, the workflow structure comprises a plurality of workflow components. A workflow component may correspond to a milestone, task, state, node in a Directed Acyclic Graph, rule-evaluation step, or other discrete unit of workflow logic.

In some embodiments, a workflow component is associated with one or more preconditions that must be satisfied before execution; in other embodiments, a workflow component may execute without an explicit precondition. For example, a periodic reconciliation component may be configured to automatically execute at scheduled intervals (such as once per day or once per hour) to recalculate cost summaries, update progress metrics, or refresh scoring objects based on the current state of the structured cost object and workflow components. The periodic reconciliation component may execute according to a time-based trigger rather than requiring completion of any particular upstream workflow component as a precondition. In another example, a notification component may be configured to send a reminder to a client or professional when a workflow component remains incomplete for more than a threshold time period. The notification component may execute when the threshold is exceeded, without requiring an explicit precondition referencing completion of another workflow component. Action items may include client action items or professional action items that specify tasks to be performed by a client participant, a professional participant, or another user role. Verified events may include document uploads, digital signatures, timestamped confirmations, external system validations, or other machine-detectable events that confirm performance of the action items.

In some embodiments, at least some workflow components are configured primarily as system-internal components that perform automated checks, calculations, routing decisions, or state updates without requiring a client action item or a professional action item. Other workflow components may combine automated operations with client or professional action items. The workflow structure may define dependency-resolved execution relationships between workflow components, including ordering constraints, conditional branching, parallel execution paths, and prerequisite relationships, so that activation of a particular workflow component is controlled based on completion of one or more other workflow components and their associated verified events.

In some embodiments, the milestone directed acyclic graph compiler 226 generates a milestone structure 228 in which respective milestones operate as workflow components. In alternative embodiments, the workflow generation component may construct workflow components using non-graph representations, such as rule-based engines, state machines, or generative task sequences, while still associating each workflow component with preconditions, action items, and verified events. The runtime workflow tracker 238 may interpret the workflow structure by monitoring workflow components, detecting verified events, updating component status, and activating downstream workflow components in accordance with the defined dependency relationships.

In some embodiments, the cost binder 230 is configured to receive user-specified cost values via the user interface, such as professional-entered flat fees, hourly rates, caps, or discount adjustments. The cost binder 230 may normalize these user-specified values into the structured cost object 232, which may include standardized fields, metadata, and variance-limiter parameters. In other embodiments, the cost binder 230 may generate or update the structured cost object 232 based on one or more of: domain-specific pricing templates, historical pricing models, or machine-learning-based cost estimates. Any combination of user-specified inputs and system-generated values may be incorporated into a structured cost object.

In some embodiments, a cost engine includes a Cost Binder 230 and may further include a Dynamic Billing Engine 254 configured to recalculate billing values during workflow execution.

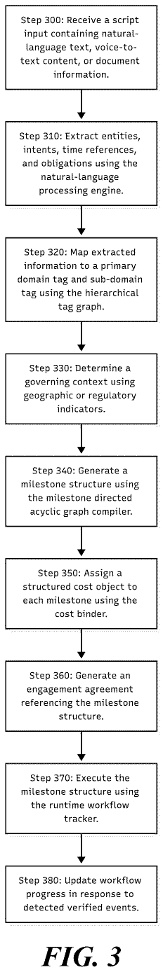

Referring to FIG. 3, a flowchart illustrates an example method for transforming a script input into an executable workflow. Each step may be performed by one or more processors executing instructions stored in one or more memory devices. The steps may occur in sequence or may include additional intermediate operations without departing from the described method.

At step 300, the method may include receiving a script input comprising natural-language text, voice-generated text, or document information. This step may be executed through a user interface that accepts typed text, spoken input, uploaded files, or other client-provided materials. The script input may be normalized to remove formatting inconsistencies or noise before downstream processing begins. The system may store the script input in a structured buffer or database record so that it can be accessed by multiple modules. This step may initiate the processing sequence performed by the method.

At step 310, the method may include processing the script input using a Natural-Language Processing Engine configured to extract entities, intents, time references, and obligations. The Natural-Language Processing Engine may apply linguistic models, neural language embeddings, or rule-based extraction techniques to interpret the meaning of the script input. The extracted entities may include persons, organizations, documents, locations, or object references, and the intents may reflect actions, requests, or goals implied in the text. Time references may include deadlines, dates, or periods relevant to workflow sequencing. Obligations may be derived from the language and may represent duties, requirements, or expected actions identified in the script input.

At step 320, the method may include mapping the extracted entities and intents to a primary domain tag and a sub-domain tag using a Hierarchical Tag Graph. The Hierarchical Tag Graph may store domain categories and sub-domain categories in a graph structure that includes metadata describing rules, role assignments, and document requirements. The system may evaluate the extracted information against the metadata associated with each domain or sub-domain to determine the most appropriate classification. This classification may serve as the basis for all subsequent workflow generation steps and may provide a consistent taxonomy for cross-domain workflow management. The mapping may result in a domain-specific representation of the script input.

At step 330, the method may include determining a governing context using a Context Resolver configured to analyze geographic indicators or regulatory indicators associated with the script input. The governing context may include region-specific procedural rules, regulatory guidelines, or jurisdictional requirements relevant to workflow generation. The Context Resolver may evaluate textual cues, location metadata, user-supplied information, or system defaults to determine which context applies. In some implementations, the Context Resolver may apply weighted inference or conditional logic to resolve ambiguous context signals. The output of this step may include a context object representing the applicable regional or regulatory environment.

At step 340, the method may include generating a milestone structure using a Milestone Directed Acyclic Graph Compiler. The compiler may create milestones using the primary domain tag, sub-domain tag, and governing context determined in prior steps. Each milestone may include at least one precondition, at least one client action item or professional action item, and at least one verified event that marks milestone completion. The Directed Acyclic Graph Compiler may organize the milestones into a Directed Acyclic Graph so that the execution order is deterministic and free of cyclical dependencies. The milestone structure produced at this step may define the procedural sequence used for workflow execution.

At step 350, the method may include assigning a structured cost object to each milestone using a Cost Binder. The structured cost object may include cost fields representing professional fees, resource estimations, time requirements, or other financial data associated with the milestone. The Cost Binder may apply a variance limiter that constrains cost deviations within predefined bounds. The structured cost object may be dynamically updated if the milestone structure or governing context changes. This step may ensure that each milestone includes transparent and predictable financial information.

At step 360, the method may include generating an engagement agreement using an Engagement Generator. The engagement agreement may contain contractual terms referencing the milestone structure and the structured cost objects assigned in step 350. The Engagement Generator may produce a format suitable for electronic signature and may populate the agreement with workflow-specific terms and obligations. This agreement may establish the procedural and financial framework that governs workflow execution. In some embodiments, the engagement agreement may also reference preconditions, action items, and verified events associated with each milestone.

At step 370, the method may include executing the milestone structure using a Runtime Workflow Tracker. The Runtime Workflow Tracker may monitor the status of milestones, evaluate whether preconditions have been satisfied, and activate subsequent milestones based on their dependency order in the Directed Acyclic Graph. The tracker may also evaluate whether verified events have been detected for milestone completion. It may coordinate with user-facing interfaces, professional tools, or external systems to track progress throughout workflow execution. The Runtime Workflow Tracker may then update workflow state information and trigger notifications or task transitions.

At step 380, the method may include updating workflow progress when the Runtime Workflow Tracker detects a verified event. The verified event may include a document upload, digital signature, timestamped confirmation, or system-validated procedural milestone. Upon detecting a verified event, the Runtime Workflow Tracker may update milestone status, activate downstream milestones, and generate audit-log entries. This process may allow the workflow to advance automatically and consistently. This final step may complete one iteration of workflow execution and may prepare the system for additional verified events or follow-up tasks.

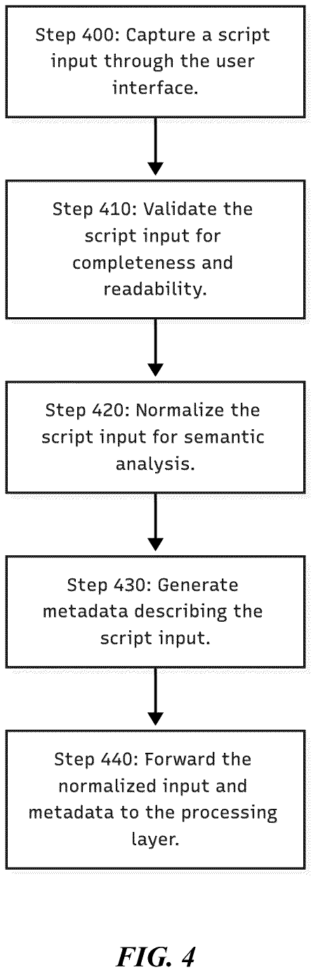

Referring to FIG. 4, a flowchart illustrates an example sequence of operations that may be performed to capture, validate, normalize, and prepare a script input for downstream semantic analysis within the system. The flowchart includes a series of steps executed primarily by the script input module 218 operating within the input layer 242, and these steps may occur in the order shown or in a different order depending on system configuration. FIG. 4 depicts how user-provided information transitions from raw natural-language input, voice-generated text, or document content into a structured and normalized format suitable for processing by the natural-language processing engine 220. Each step is shown with its own reference numeral and may involve interaction with additional components such as the display module 216 or database engine 204. The flowchart provides an overview of how the system initiates the workflow pipeline by transforming unstructured input into analyzable data.

At step 400, the system may initiate capture of a script input through the user interface accessible to a client user or professional user. The script input may include natural-language text typed directly into an input panel, voice-to-text content generated through a microphone interface, or uploaded documents provided in various formats. The script input module 218 may preprocess the data by removing formatting anomalies, converting voice data into text, or extracting readable content from attached files. This preprocessing ensures that the script input is clean, normalized, and ready for computational interpretation. The system may store a temporary representation of the script input for subsequent processing steps.

At step 410, the system may validate the script input to confirm that it contains sufficient content for downstream semantic analysis. The script input module 218 may check for empty or incomplete text, corrupted document files, or unreadable voice-to-text transcriptions. If information is insufficient, the system may prompt the user to provide additional detail. The validation step ensures that the processing layer 244 receives a complete and interpretable data sample. This step may also record metadata describing the input source, timestamp, and user identity.

At step 420, the system may normalize the script input by applying text-cleaning procedures, including removal of extraneous symbols, harmonization of character sets, and segmentation of text into analyzable units. For voice-to-text submissions, this step may include acoustic cleanup and phrase alignment. The script input module 218 may also classify file uploads by type, such as PDFs, images, or text files, and may extract embedded text where applicable. The normalization step may improve the accuracy of semantic extraction performed by the natural-language processing engine 220. Normalized content may be stored in memory and passed to the processing layer 244.

At step 430, the script input module 218 may generate metadata associated with the script input, including document timestamps, user identifiers, device identifiers, and content categories. This metadata may be used by downstream components for workflow attribution, audit trails, or jurisdictional inference. The system may also tag the input with contextual labels such as source language, content length, and file-type classification. These metadata structures may be stored within the database engine 204 for later retrieval and cross-referencing. Metadata generated at this step may support the operations of the natural-language processing engine 220 and context resolver 224.

At step 440, the script input module 218 may forward the normalized script input and its associated metadata to the processing layer 244. This transfer may be performed using secure internal messaging channels, API calls, or shared memory structures. The processing layer 244 may receive the script input as the foundation for semantic extraction, domain classification, and governing context determination. This transition completes the script input capture process and prepares the system for natural-language interpretation operations. The system may log the transition for audit-log entries 240.

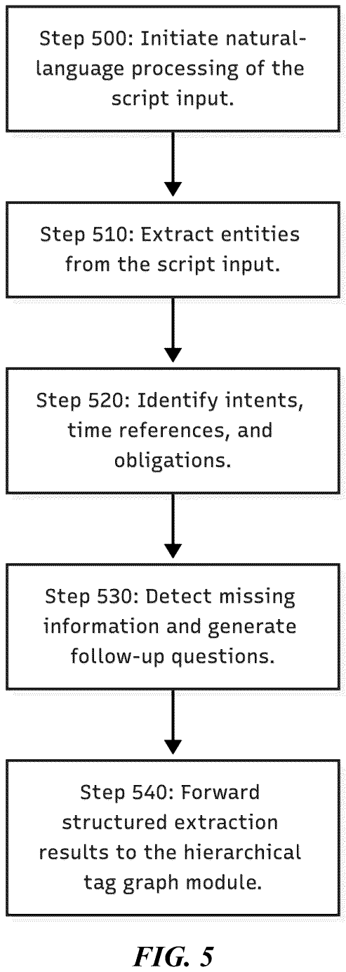

Referring to FIG. 5, a flowchart illustrates an example sequence of operations performed by the natural-language processing engine 220 within the processing layer 244. FIG. 5 depicts how the system interprets a script input by extracting entities, intents, time references, and obligations that form the semantic foundation for downstream domain classification and context determination. The steps shown may be executed in the order illustrated or in a different order depending on system configuration and may involve parallel analysis pipelines or iterative refinement. The flowchart highlights how raw textual content becomes structured information that the hierarchical tag graph module 222 and context resolver 224 may use to initiate workflow generation. Each step in FIG. 5 includes its own reference numeral and reflects a distinct function within the natural-language interpretation process.

At step 500, the method may include initiating processing of the script input previously normalized and validated by the script input module 218. The natural-language processing engine 220 may load the input into its semantic processing pipeline, which may include tokenization, segmentation, and linguistic preprocessing stages. The engine may determine whether the script input contains multiple segments, such as separate paragraphs or combined text-and-document inputs and may allocate internal resources accordingly. This step prepares the script input for deeper semantic analysis by establishing boundaries, identifying linguistic structures, and preparing auxiliary metadata required for subsequent extraction. The system may record this initiation event for internal tracking or audit-log entries 240.

At step 510, the method may include extracting entities from the script input using entity-recognition models or rule-based entity grammars. Entities may include persons, organizations, locations, dates, document types, transactional references, or any subject matter identifiable within the text. The natural-language processing engine 220 may apply named-entity recognition models, pattern-matching rules, or hybrid neural architectures to detect entity occurrences. It may also resolve co-references, such as identifying when multiple expressions refer to the same entity. Extracted entities may then be formatted into structured objects and forwarded to later steps.

At step 520, the method may include determining intents, time references, and obligations contained in the script input. Intents may reflect actions that the user seeks to take, or actions implied by the language, such as requests, complaints, filings, submissions, or needs for assistance. The natural-language processing engine 220 may also detect time references, including explicit dates, implied time periods, and deadline indicators, which may influence milestone sequencing. Obligations may include responsibilities, requirements, or legally significant actions described in the script input. Together, these extracted features may represent the procedural meaning of the script input.

At step 530, the natural-language processing engine 220 may determine whether the script input lacks information required for milestone generation. This evaluation may compare the extracted entities, intents, time references, and obligations against heuristic or rule-based requirements associated with domain-specific workflows. If information gaps are identified, the engine may generate follow-up questions to collect the missing data. These follow-up questions may be phrased naturally and designed to solicit precise responses that complete milestone preconditions. The system may then reprocess updated script input when responses are received.

At step 540, the method may include forwarding the structured representation of extracted entities, intents, time references, and obligations to the hierarchical tag graph module 222. This data transfer may occur through internal messaging buses, shared memory regions, or direct method calls depending on implementation. The structured data may enable accurate classification of the script input into a primary domain tag and sub-domain tag. The natural-language processing engine 220 may also provide confidence scores or metadata describing extraction certainty. This step concludes the natural-language interpretation process and transitions control to domain classification.

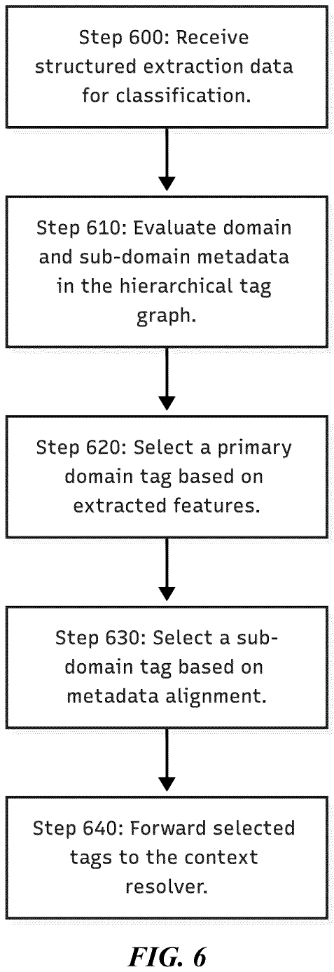

Referring to FIG. 6, a flowchart illustrates an example sequence of operations performed by the hierarchical tag graph module 222 within the processing layer 244 to classify the script input into a primary domain tag and a sub-domain tag. FIG. 6 shows how the system evaluates extracted entities, intents, time references, and obligations to determine which domain categories and sub-domain categories apply to the matter described in the script input. The steps may occur in the order depicted, or they may be reordered or run in parallel depending on system configuration. The hierarchical mapping process may include evaluating metadata associated with domain categories, assessing node relevance, and computing similarity scores to identify the most appropriate tags. Each step in FIG. 6 includes its own reference numeral for clarity and cross-referencing within the Detailed Description.

At step 600, the hierarchical tag graph module 222 may receive structured data from the natural-language processing engine 220, including extracted entities, intents, time references, and obligations. This structured data may serve as the initial input for evaluating which domain categories or sub-domain categories apply to the script input. The module may parse the structured data, normalize the extracted features into a consistent format, and prepare them for comparison against hierarchical nodes stored in memory. The system may record this transition to support audit-log entries 240. This step establishes the foundation for the domain classification process.

At step 610, the module may evaluate metadata associated with each node in the Hierarchical Tag Graph. Metadata may include domain descriptions, sub-domain definitions, required documents, procedural rules, jurisdictional considerations, and other structured attributes that inform classification. The module may compare the structured data received at step 600 against this metadata to identify potentially relevant nodes. This comparison may use rule-based logic, scoring models, or hybrid criteria depending on system configuration. The evaluation may reduce the number of candidate nodes to a manageable subset.

At step 620, the module may determine a primary domain tag by matching entities and intents to domain-level metadata that best reflect the nature of the script input. This mapping may involve computing similarity scores, identifying keyword-to-domain relationships, and applying domain weighting rules. If multiple candidate domains are identified, the module may rank the domains using probabilistic or deterministic scoring methods. The highest-ranked domain may be selected as the primary domain tag. This step provides the broadest categorical classification for the workflow.

At step 630, the system may determine a sub-domain tag by evaluating metadata associated with sub-domain categories nested beneath the primary domain tag. The hierarchical tag graph module 222 may compare extracted features such as obligations, time references, and contextual indicators against the sub-domain metadata. If multiple sub-domains appear relevant, the system may compute a weighted score for each sub-domain and select the one that aligns most directly with the structured data. The selected sub-domain tag may inherit metadata or rule sets from its parent domain node. This step provides the narrower classification used for workflow generation.

At step 640, the hierarchical tag graph module 222 may forward the selected primary domain tag and sub-domain tag to the context resolver 224. This transfer may allow the context resolver 224 to determine whether jurisdictional or regulatory variations influence how the selected tags should be interpreted. The module may also include confidence scores or metadata describing the decision path used to select the domain tags. These outputs may be used by the milestone directed acyclic graph compiler 226 when constructing the milestone structure. The domain classification flow ends when control passes to the context resolver 224.

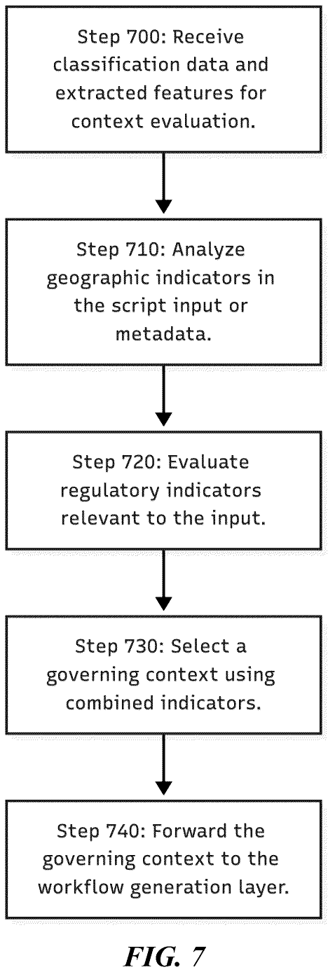

Referring to FIG. 7, a flowchart illustrates an example sequence of operations performed by the context resolver 224 within the processing layer 244 to determine the governing context applicable to the script input. The flowchart depicts how the system evaluates geographic indicators, regulatory indicators, and contextual cues extracted by the natural-language processing engine 220 to identify which jurisdictional or regulatory rules apply. The steps shown may be executed sequentially or in parallel depending on system configuration and may rely on both direct text analysis and metadata inferred from user profiles or device settings. Each step includes a reference numeral indicating its position within the flowchart, and the overall process enables accurate contextual alignment for downstream workflow generation. By determining the governing context at this stage, the system ensures that all subsequent milestone generation reflects correct rule sets associated with the user's scenario.

At step 700, the context resolver 224 may receive the primary domain tag and sub-domain tag selected by the hierarchical tag graph module 222 along with extracted entities, intents, time references, and obligations from the natural-language processing engine 220. The module may also access metadata describing the user's device location, provided jurisdictional preferences, or regulatory selections made during prior interactions. The system may merge these data sources into a structured input object representing the contextual indicators available at this stage. This input object may form the basis of the analysis that determines which governing context applies. The received data may be logged for audit purposes and forwarded to the next evaluation step.

At step 710, the system may analyze geographic indicators contained in the script input or user metadata. These indicators may include explicit location references found in the text, such as city names, state names, or country identifiers, as well as implicit metadata such as IP-based geolocation or user-provided account information. The system may weigh these indicators based on their reliability and specificity, assigning higher weight to explicit textual references. When conflicting indicators exist, the context resolver 224 may apply predefined decision rules or use weighted inference to identify the most plausible location. The output of this step may include one or more candidate geographic contexts.

At step 720, the context resolver 224 may evaluate regulatory indicators associated with the script input. Regulatory indicators may include statutory references, compliance terminology, jurisdiction-specific procedures, or domain-specific rules inferred from the primary domain tag and sub-domain tag. The system may compare these indicators against stored regulatory metadata in the database engine 204 to determine whether the script input aligns with federal, state, local, or industry-specific frameworks. This evaluation may also incorporate temporal attributes such as effective dates or expiration periods associated with certain regulations. The system may generate a list of candidate regulatory contexts after this evaluation.

At step 730, the system may combine geographic indicators and regulatory indicators to select a governing context. This step may involve merging candidate contexts, resolving conflicts using weighted scoring, and applying rule-based logic to ensure alignment with domain-specific constraints. The context resolver 224 may also consider user preferences or explicit selections when multiple plausible contexts exist. The selected governing context may include jurisdictional information, applicable procedural rules, required documentation, or associated regulatory limits. The system may store this governing context for use during milestone generation.

At step 740, the context resolver 224 may forward the selected governing context to the workflow generation layer 246, where the milestone directed acyclic graph compiler 226 may use the governing context to generate contextually appropriate milestones. The system may also attach metadata indicating how the governing context was chosen, allowing downstream components to reference the decision path if updates or corrections are required. The processed governing context may be written to the database engine 204 for future retrieval or auditing. This transition may complete the context determination phase of the process. Control may then pass to the milestone directed acyclic graph compiler 226 to begin workflow generation.

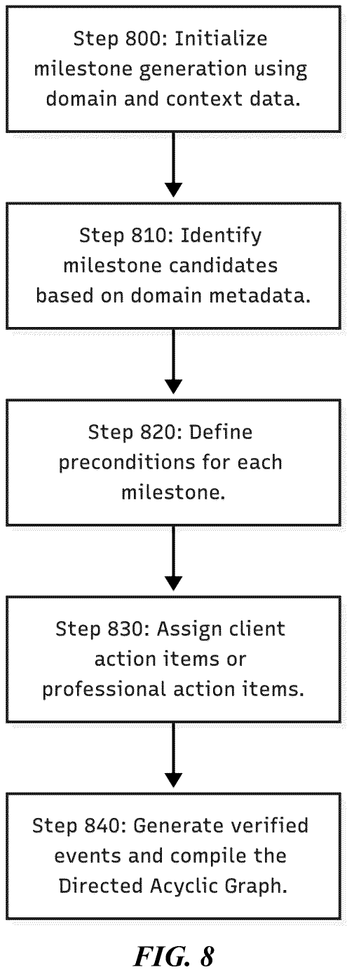

Referring to FIG. 8, a flowchart illustrates an example sequence of operations performed by the milestone directed acyclic graph compiler 226 within the workflow generation layer 246 to generate a milestone structure suitable for workflow execution. FIG. 8 shows how the system uses the primary domain tag, sub-domain tag, governing context, and extracted features to create milestones, define their dependencies, and organize them within a Directed Acyclic Graph. The steps may be executed in the sequence illustrated or may involve parallel evaluation depending on implementation design. This flowchart depicts how the system translates contextual, semantic, and domain-specific information into a structured series of procedural steps. Each step is represented by a corresponding reference numeral.

At step 800, the system may initiate milestone generation by creating an empty milestone structure that will store all milestones produced during this process. The milestone directed acyclic graph compiler 226 may gather the primary domain tag, sub-domain tag, and governing context provided by the processing layer 244, along with extracted entities, intents, time references, and obligations supplied by the natural-language processing engine 220. The compiler may also retrieve domain metadata from the hierarchical tag graph module 222 to determine which procedural components are relevant. This initialization stage establishes the foundational data elements required for constructing the Directed Acyclic Graph. The system may log the initialization event for audit-log entries 240.

At step 810, the system may identify milestone candidates by evaluating domain metadata associated with the selected primary domain tag and sub-domain tag. These milestone candidates may represent common procedural requirements, document submissions, approvals, communications, or professional tasks associated with the relevant domain. The milestone directed acyclic graph compiler 226 may examine extracted entities, intents, and obligations to determine which milestone candidates apply to the script input. The compiler may refine the list by discarding milestones not relevant to the governing context or by adding milestones triggered by contextual variations. This step results in a preliminary set of potential milestones.

At step 820, the system may define preconditions for each milestone. Preconditions may include factual confirmations, document uploads, external validations, or other requirements that must be satisfied before the milestone can proceed. The compiler may map extracted features to these preconditions, identifying which preconditions are met and which are unmet. For unmet preconditions, the system may rely on follow-up questions generated earlier by the natural-language processing engine 220 or may flag the milestone for delayed activation. This structured representation of preconditions ensures that milestone completion is verifiable and logically consistent.

At step 830, the system may assign at least one client action item or professional action item to each milestone. Client action items may include tasks that a user can complete independently, while professional action items may require review, drafting, analysis, or submission by a qualified professional. The milestone directed acyclic graph compiler 226 may determine which action items apply by evaluating domain rules, contextual requirements, and the complexity of the underlying tasks. The action assignment process may also incorporate user role information managed by the user module 212. These action assignments define the functional responsibilities within the workflow.

At step 840, the system may define at least one verified event for each milestone and organize the milestones into a Directed Acyclic Graph. A verified event may be a document upload, digital signature, timestamped action, or system-validated confirmation that proves completion of the milestone's action items. The compiler may determine milestone dependencies by reviewing procedural sequences specified in domain metadata, contextual requirements, and extracted temporal references. The Directed Acyclic Graph may then be built by linking each milestone to subsequent milestones that depend on its verified event. This step completes milestone generation and results in a fully structured milestone structure that can be executed by the runtime workflow tracker 238.

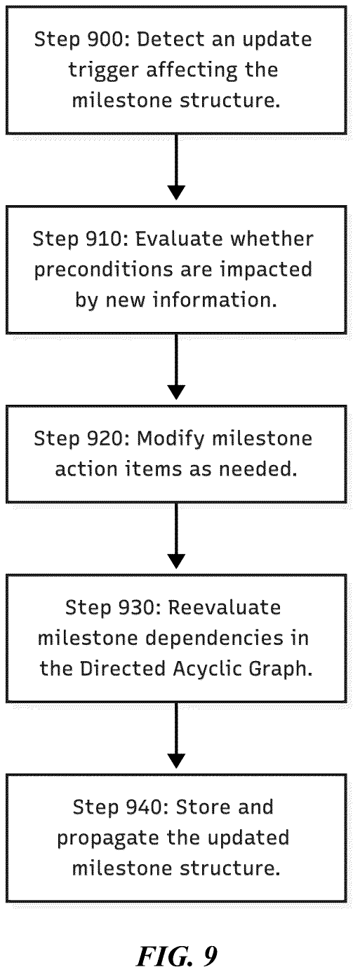

Referring to FIG. 9, a flowchart illustrates an example sequence of operations that may be performed to update the milestone structure 228 in response to new information, new verified events, or changes in the governing context. FIG. 9 shows how the system evaluates whether the existing Directed Acyclic Graph requires modification and how updated milestone information propagates through the workflow. The steps may be executed in the order illustrated or in a different order depending on the type of update detected. Updates may be triggered by user responses, adjusted context signals, or external notifications that affect milestone eligibility or sequencing. Each step is shown with its own reference numeral to support clear cross-referencing.

At step 900, the system may detect an update trigger that indicates a change in workflow conditions. This trigger may originate from newly submitted user input, completion of a verified event, or detection of new contextual information from the context resolver 224. The runtime workflow tracker 238 may relay the trigger to the milestone directed acyclic graph compiler 226 for further evaluation. The detection of this update trigger may be logged in audit-log entries 240. This step ensures that changes in workflow conditions are captured in real time.

At step 910, the system may evaluate whether the detected update affects any existing milestone preconditions. The milestone structure 228 may include stored relationships defining how preconditions align with domain rules and contextual constraints. If the new information satisfies or invalidates one or more preconditions, the system may identify which milestones are impacted. This evaluation ensures that dependent milestones maintain logical consistency. The system may also determine whether new follow-up questions are required to resolve remaining gaps.

At step 920, the milestone directed acyclic graph compiler 226 may determine whether milestone action items must be modified. This may include reassigning a task from a client action item to a professional action item or vice versa based on updated role requirements or user responses. Changes in procedural requirements, document submissions, or contextual factors may also prompt the compiler to update action items. This reassignment may ensure that workflow responsibilities remain accurate. The compiler may record these updates for later retrieval.

At step 930, the system may evaluate milestone dependencies within the Directed Acyclic Graph. If new information affects the order or conditional activation of milestones, the compiler may rebuild the relevant graph segments. This may include removing outdated connections, creating new dependencies, or adjusting parallel execution paths. The Directed Acyclic Graph may be updated incrementally or as a whole depending on the scope of the change. The system may maintain version histories of the graph structure.

At step 940, the updated milestone structure 228 may be stored and propagated to the runtime workflow tracker 238. The runtime workflow tracker 238 may use the updated structure to adjust ongoing workflow execution. The system may notify users when updates affect upcoming milestones or assigned action items. The updated structure may also be stored for future audit or review. This step concludes the milestone structure update process.

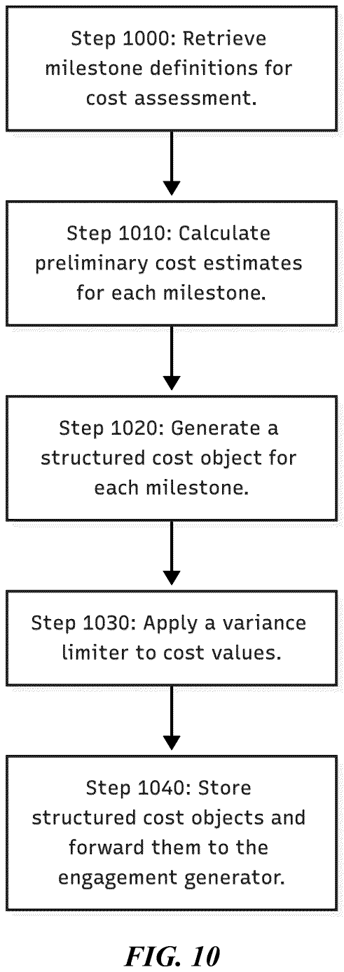

Referring to FIG. 10, a flowchart illustrates an example sequence of operations performed by the cost binder 230 to assign structured cost objects 232 to milestones in the milestone structure 228. FIG. 10 shows how the system calculates, adjusts, and binds cost information to each milestone to produce transparent and predictable pricing. These steps may be executed in series or combined into a composite pipeline depending on system configuration. The cost binder 230 may communicate with domain metadata, historical pricing models, and user-selected parameters. Each step includes a numerical reference for clarity.

At step 1000, the cost binder 230 may retrieve milestone definitions and associated metadata from the milestone structure 228. The metadata may include action items, expected durations, required documents, and professional or client task types. The cost binder 230 may evaluate these attributes to determine what cost factors apply to the milestone. This evaluation may rely on domain-specific pricing templates or generalized cost models. The retrieved information forms the basis for cost object generation.

At step 1010, the cost binder 230 may calculate preliminary cost estimates for each milestone. These estimates may include time-based fees, fixed-fee components, material costs, or other measurable resource allocations. The cost binder 230 may apply formulaic rules stored within domain-specific metadata or may utilize machine-learning models trained on historical data. The system may produce a raw cost estimate object representing these initial values. These calculations may be refined in subsequent steps.

At step 1020, the system may generate a structured cost object 232 for each milestone by formatting the preliminary cost estimates into a standardized structure. This structure may include cost categories, numerical values, allowable modifications, and cross-references to the associated milestone. The structured cost object 232 may also include annotations describing how each cost element was derived. This formatting ensures that downstream components can interpret and present the cost information consistently. The structured cost object 232 becomes the financial representation of the milestone.

At step 1030, the cost binder 230 may apply a variance limiter to the structured cost object 232. The variance limiter may restrict certain cost elements to fall within predetermined thresholds or ranges to prevent excessive deviation. The variance limiter may operate using static rule sets or dynamic logic based on historical data. This ensures that cost estimates remain predictable and stable even when workflow conditions change. The adjusted structured cost object 232 may then be flagged as finalized for the current iteration.

At step 1040, the finalized structured cost objects 232 may be stored in the database engine 204 and forwarded to the engagement generator 234. The engagement generator 234 may use the cost objects to assemble engagement agreements that reflect milestone-level financial commitments. The runtime workflow tracker 238 may also access these cost objects during execution for billing or notification purposes. The system may maintain version control on cost objects to track changes over time. This step concludes the cost assignment process.

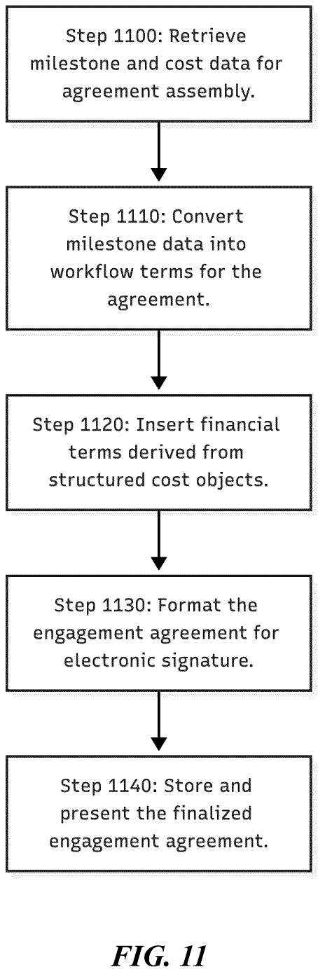

Referring to FIG. 11, a flowchart illustrates an example sequence of operations performed by the engagement generator 234 to create an engagement agreement 236. FIG. 11 shows how milestone structure data and structured cost objects are combined to form a digitally signable agreement. The steps may follow the illustrated sequence or may be modified depending on system needs or domain requirements. The engagement generator 234 may collect template data, workflow details, and cost information from multiple components. Each step is represented with a unique reference numeral.

At step 1100, the engagement generator 234 may retrieve the milestone structure 228 and associated structured cost objects 232. This retrieval may include loading milestone descriptions, preconditions, action items, verified events, and cost values. The engagement generator 234 may interpret these elements to determine how they should be expressed within an engagement agreement. The system may select relevant template sections depending on the domain and governing context. This step provides the underlying content for agreement assembly.

At step 1110, the system may assemble workflow terms by converting milestone details into contractual text. This may include describing the responsibilities associated with each milestone, detailing required actions, and establishing procedural expectations. The engagement generator 234 may also include references to structured cost objects 232 and their associated variance limits. The resulting text may be structured so that users can clearly understand the procedural flow. These workflow terms form the core of the agreement.

At step 1120, the system may incorporate financial terms into the engagement agreement. These terms may reflect fee structures, payment schedules, or billing triggers tied to verified events or workflow milestones. The engagement generator 234 may also include disclaimers, regulatory disclosures, or jurisdictional statements associated with the governing context. The financial section may be formatted in both human-readable and machine-readable forms to support downstream payment processing. This step finalizes the cost-related portion of the agreement.

At step 1130, the engagement generator 234 may format the engagement agreement 236 for electronic signature. The system may integrate with external signature APIs, identity verification services, or authentication modules to ensure secure execution. The engagement generator 234 may embed metadata representing the milestone structure and cost objects to preserve the agreement's link to the workflow. Multiple signature fields may be included depending on the number of required signatories. This formatting stage prepares the agreement for user review and execution.

At step 1140, the engagement agreement 236 may be stored in the database engine 204 and presented to the user through the display module 216. The system may log the agreement generation event in audit-log entries 240. The agreement may then be transmitted for signatures or routed to professionals for review. Once executed, its terms may govern workflow execution performed by the runtime workflow tracker 238. This step completes the engagement agreement generation flow.

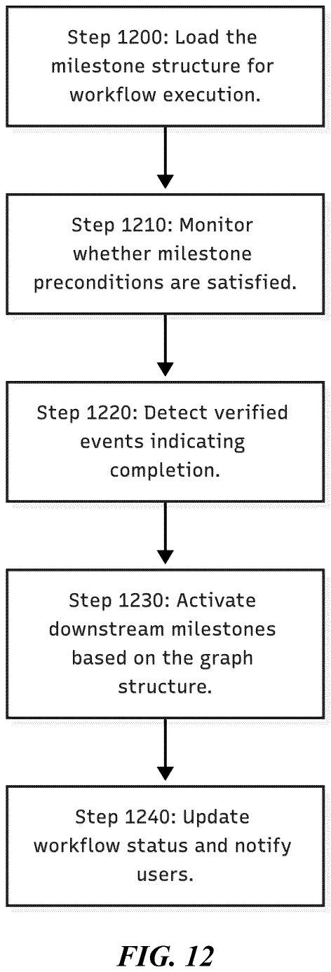

Referring to FIG. 12, a flowchart illustrates the operations performed by the runtime workflow tracker 238 as it manages workflow execution based on the milestone structure 228. FIG. 12 describes how the system monitors milestones, detects verified events, triggers next steps, and ensures that workflow state transitions remain consistent with the Directed Acyclic Graph. These operations may rely on user actions, professional actions, and external confirmations. Each step in this flowchart includes its own reference numeral. The flow emphasizes real-time execution and procedural tracking.

At step 1200, the runtime workflow tracker 238 may load the milestone structure 228, including all milestones, action items, dependencies, and verified event definitions. It may also load context metadata and structured cost objects 232 relevant to workflow progression. The tracker may initialize internal monitors or listeners to detect actions taken by users or professionals. This setup phase prepares the tracker to supervise workflow execution. The system may log the initialization for auditing.

At step 1210, the system may monitor for completion of milestone preconditions. Preconditions may include document uploads, confirmations, or other requirements needed to activate a milestone. The runtime workflow tracker 238 may check these conditions automatically by comparing user inputs or document submissions against the stored milestone definitions. If unmet preconditions remain, the tracker may notify users and request additional information. This ensures that milestones become active only when logically appropriate.

At step 1220, the runtime workflow tracker 238 may detect verified events corresponding to milestone completion. Verified events may include digital signatures, timestamped actions, or system-validated confirmations. The tracker may validate these events through internal logic or via integration with external verification services. Once a verified event is confirmed, the system may mark the milestone as complete. Verified events may also trigger entries in audit-log entries 240.

At step 1230, the system may activate downstream milestones based on the Directed Acyclic Graph. This activation may include enabling new action items, notifying users or professionals of their responsibilities, or unlocking additional workflow sections. Dependencies stored in the Directed Acyclic Graph ensure that milestones become active in a deterministic order. The runtime workflow tracker 238 may also evaluate whether parallel execution paths are available. This movement from one milestone to the next maintains procedural continuity.

At step 1240, the runtime workflow tracker 238 may update workflow status and synchronize changes with user interfaces, professional dashboards, and administrative consoles. The tracker may propagate updates to the display module 216 and maintain a consistent representation of workflow progression across devices. This may include generating notifications when new milestones become active or when workflow delays occur. The system may also record status changes in audit-log entries 240. This completes the workflow execution flow.

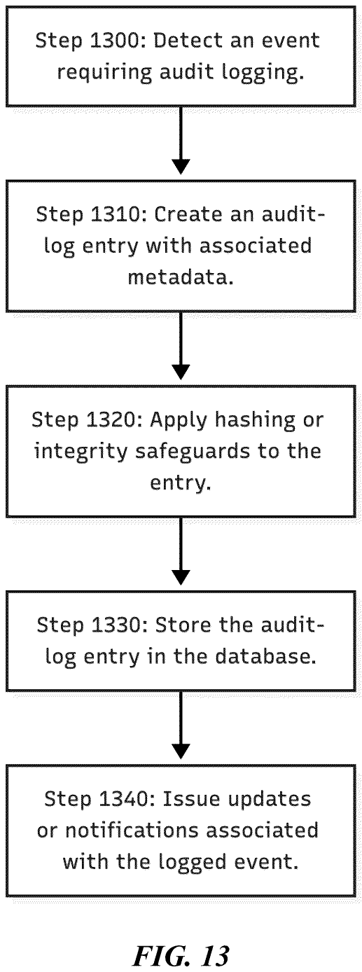

Referring to FIG. 13, a flowchart illustrates an example sequence of operations performed to create, validate, and store audit-log entries 240. FIG. 13 shows how the system documents workflow events, verified actions, and user interactions to maintain traceable and verifiable records. The steps may occur automatically during workflow execution and may support compliance or review processes. Each step includes its own reference numeral to support cross-referencing. The flow emphasizes secure and consistent historical recordkeeping.

At step 1300, the system may detect an event that requires logging, such as a verified event, a user action, or a milestone update. The runtime workflow tracker 238 may generate internal signals that indicate when an event has occurred. The system may assign an event identifier and capture metadata describing the associated milestone or action. These preliminary details form the basis of the audit-log entry. The system may then prepare the data for structuring.

At step 1310, the system may assemble event metadata into an audit-log entry object. This object may include a timestamp, a role identifier, an event identifier, and optional contextual fields. The system may apply formatting rules to ensure that each audit-log entry adheres to consistent structure. Additional fields may include governing context identifiers or cost-related references. This structured entry provides a reliable record of the event.

At step 1320, the system may apply hashing, encryption, or other integrity-preserving mechanisms to the audit-log entry. Hashing may allow the system to detect tampering, while encryption may preserve data confidentiality. The system may also compute hash-chain links to preserve the chronological order of events. These security measures may ensure that the audit-log entries 240 remain reliable. The integrity-protected entry may then be queued for storage.

At step 1330, the system may store the audit-log entry in the database engine 204. This storage process may include appending the entry to an existing immutable log or creating a replicated copy in a distributed storage environment. The system may verify that the entry was successfully written and may generate alerts in case of storage failures. Stored entries may later be retrieved for review or reporting. This step ensures persistent retention of workflow history.

At step 1340, the system may propagate notifications or updates associated with the logged event. These notifications may inform users, professionals, or administrators about workflow progress or system activity. The system may also evaluate whether logged events require downstream updates to milestones, cost objects, or engagement agreements. Audit-log entries 240 may support transparency and traceability across the workflow. This final step completes the audit logging flow.

The claims recite a specific, computer-implemented architecture comprising multiple interconnected modules that perform coordinated data transformations using defined computing structures. The system includes a script input module 218, a natural-language processing engine 220, a hierarchical tag graph module 222, a context resolver 224, a milestone directed acyclic graph compiler 226, a milestone structure 228, a cost binder 230, structured cost object 232, engagement generator 234, engagement agreement 236, runtime workflow tracker 238, and audit-log entries 240 operating across defined layers 242-250. These components are not generic placeholders but instead implement expressly claimed data structures, computational routines, and machine-specific operations configured to transform unstructured natural-language input into an executable workflow. The claimed system therefore recites a concrete computing solution that addresses technical challenges associated with extracting structured data from heterogeneous natural-language sources and generating a deterministic Directed Acyclic Graph based on contextual rules and domain metadata.

The claimed operations cannot be performed as a mental process or by manual paper-based techniques because they require machine-executed functions such as linguistic tokenization, entity extraction, classification against a hierarchical tag graph, context inference using geographic and regulatory indicators, and compilation of graph structures that ensure acyclic workflow sequencing. These steps rely on specialized processor-executed instructions stored within one or more memory devices and are implemented using engineering constructs such as graph compilers, semantic parsers, context resolvers, and automated DAG generation procedures. The milestone directed acyclic graph compiler 226, hierarchical tag graph module 222, and runtime workflow tracker 238 perform computational tasks that depend on computer memory allocation, pointer-based data structures, and graph traversal algorithms not performable by human reasoning. As such, the claimed subject matter cannot practically be carried out without the specific computing components recited in the claims.

The claims also improve the functioning of the computer itself by enabling the computing system to analyze and classify natural-language input in a manner not achievable by traditional systems. The natural-language processing engine 220 extracts entities, intents, time references, and obligations using structured machine operations rather than simple text parsing, while the hierarchical tag graph module 222 maps these extracted features to domain and sub-domain classifications using a structured graph with metadata relationships. These modules allow the computing system to operate on unstructured text with enhanced accuracy and reliability, enabling subsequent modules to generate a milestone structure 228 and a Directed Acyclic Graph that reflect domain rules and governing context. This architecture therefore provides a technological improvement to computer-based workflow generation by enabling deterministic, context-aware execution paths derived from unstructured inputs.

The cost binder 230 and structured cost object 232 further demonstrate that the claims are directed to a technical system rather than to an abstract idea. These modules apply computational rules to quantify resource requirements, apply variance limiters, and bind cost objects to specific nodes within the Directed Acyclic Graph. This requires algorithmic computation and data structuring at a level that exceeds simple fee calculation or conceptual estimation. The engagement generator 234 then integrates machine-generated milestones and structured cost objects into an electronically signable engagement agreement 236, which is automatically linked to the runtime workflow tracker 238 for execution monitoring. These steps collectively demonstrate a machine-implemented chain of operations that transform natural-language inputs into structured workflow objects through specific, technical processes.

The claims therefore recite significantly more than mere organization of information or performance of professional tasks. The system produces computer-readable workflow structures, DAG-based execution graphs, and structured cost objects that are created, transformed, and executed entirely within a multi-module computing architecture. The interaction of the script input module 218, natural-language processing engine 220, hierarchical tag graph module 222, context resolver 224, and milestone directed acyclic graph compiler 226 generates new machine-readable data structures that cannot be produced without the claimed computing environment. As a result, the claims are directed to a statutory process and machine that performs specific, technical operations using defined components and are not directed to an abstract idea.

In some embodiments, the technological features described herein provide specific improvements in computer operation by coordinating interactions between the natural-language processing engine, the hierarchical tag graph module, the context resolver, the milestone directed acyclic graph compiler, the cost binder, the engagement generator, the scoring engine, the dynamic billing engine, the cohort grouping and collective workflow engine, the roles, permissions, and matching modules, and the milestone tracker. The system transforms natural-language script inputs into structured data objects and computational workflows through multiple staged processing pipelines that are executed by processors using memory-stored models and rules. These transformations generate machine-readable data structures such as extracted entity objects, classification objects, governing context objects, milestone objects, structured cost objects, scoring objects, structured billing objects, cohort grouping objects, permission objects, professional matching objects, and milestone status objects. Each of these objects contains metadata and structural fields that are created and updated by specific modules in response to computational processes rather than user mental steps. These coordinated operations modify the state of multiple layers of the application program and produce deterministic, machine-enforceable workflow sequences.

In some embodiments, the scoring engine, dynamic billing engine, cohort grouping and collective workflow engine, roles, permissions, and matching modules, and the milestone tracker contribute to improved computer functionality by performing technical evaluations and state-management operations that require structured data processing. The scoring engine computes quantitative metrics based on extracted semantic features, governing context, milestone definitions, and workflow metadata, and these metrics are used by the system to influence workflow decisions, precondition determinations, user readiness assessments, and professional suitability assignments. The dynamic billing engine recalculates structured billing objects in real time as milestones update, verified events occur, or Directed Acyclic Graph structures change, and these recalculations produce new machine-generated billing objects that update cost representations stored in memory. The cohort grouping and collective workflow engine dynamically groups users based on computational analysis of extracted and structured data, and it generates collective workflow structures that differ from individual workflows based on machine-generated cohort metadata. The roles, permissions, and matching modules assign access rights and participant responsibilities using structured rule sets, licensing metadata, and professional profiles stored in the database engine. The milestone tracker monitors milestone state and synchronization across the Directed Acyclic Graph and updates milestone status objects as verified events occur.

In some embodiments, the combined operation of these modules produces technical outcomes that cannot be performed manually because they involve continuous computational monitoring, structured decision-making, and dynamic graph reconstruction across a complex multi-layer system. The system evaluates extracted entity objects, domain tags, governing context, milestone definitions, structured cost objects, scoring objects, billing objects, and permission objects to determine operation-specific outcomes such as workflow branching, milestone activation, cost adjustments, cohort formation, and role assignments. These outcomes require algorithmic evaluations, graph traversal, rule application, and metadata normalization that occur only through computer-executed processes. The system produces sequences of machine-readable states that reflect the results of these computations and stores the results in structured formats that preserve state history and ensure procedural integrity. These operations demonstrate that the system performs more than conceptual or organizational tasks because the processes require specialized data structures, layered computational modules, and coordinated state transitions executed by processors.

In some embodiments, the system improves the functioning of the computing environment by providing a modular architecture in which each component performs operations that transform data from one structured format into another. The scoring engine transforms semantic extraction results and contextual metadata into structured scoring objects. The dynamic billing engine transforms milestone updates and structured cost objects into updated billing objects. The cohort grouping and collective workflow engine transforms extracted entities, context data, and milestone metadata into cohort grouping objects and collective Directed Acyclic Graph structures. The roles, permissions, and matching modules transform user metadata, professional profiles, and workflow requirements into permission objects and matching decisions. The milestone tracker transforms execution events, precondition updates, and Directed Acyclic Graph changes into milestone state objects. These transformations demonstrate concrete changes to data structures within memory and contribute to enhanced workflow automation and execution.

In some embodiments, the system performs continuous real-time updates to structured data objects as new information becomes available. Verified events generated during workflow execution may trigger updates to scoring objects, billing objects, cohort grouping objects, permission objects, and milestone status objects. The system may update one or more directed acyclic graphs when conditions are modified, and these graphs may be rebuilt or recalculated in part or in whole using processor-executed algorithms that analyze dependencies and evaluate node relationships. These continuous computational updates ensure that workflow states remain synchronized and that modules operate on accurate and current information. The resulting operations provide a computer-specific process that involves ongoing data evaluation, structured object generation, and adaptive workflow modification.

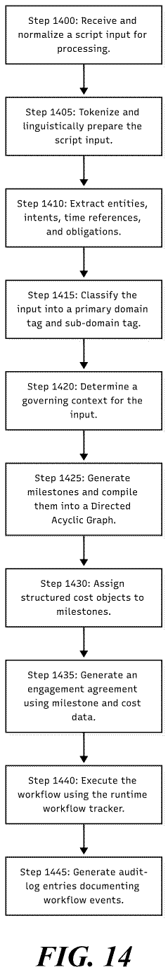

Referring to FIG. 14, a flowchart illustrates a system-wide data transformation pipeline executed by the application program 200 as it processes a script input through multiple computational stages. FIG. 14 depicts how the system transforms unstructured natural-language content into structured workflow data, binding financial information, generating contractual documents, executing milestones, and producing audit-log entries. These operations may occur sequentially or in parallel depending on system configuration, but each step contributes to a computer-implemented process that cannot be performed manually. The reference numerals 1400 through 1445 identify each step in the transformation sequence and may be used to cross-reference other sections of this specification. The pipeline highlights the specific, structured data transformations that support workflow generation and execution.

At step 1400, the system may receive the script input through the script input module 218. The script input may include natural-language text, voice-derived text, or document information, and the script input module 218 may normalize the content by removing artifacts, extracting text, and applying preliminary formatting. The module may also generate metadata describing the input source, timestamps, and file characteristics. This step ensures that the system begins with a clean and interpretable dataset. The script input object produced here forms the basis of all subsequent processing.

At step 1405, the natural-language processing engine 220 may tokenize the normalized script input and prepare it for semantic analysis. This preparation may include segmenting text, assigning part-of-speech labels, and generating internal representation structures that help the engine extract meaningful information. The system may detect sentence boundaries, identify complex expressions, and allocate memory structures needed for further extraction. This preprocessing operation enhances the quality of subsequent semantic extraction. The text is converted from an unstructured stream into a structured linguistic representation.

At step 1410, the natural-language processing engine 220 may extract entities, intents, time references, and obligations from the prepared text. These extracted features may be formatted into structured entity objects containing labeled fields, confidence scores, and semantic weights. The engine may identify obligations and time references not just from explicit keywords but also from implied linguistic patterns. If the engine detects missing information necessary for downstream processing, it may generate follow-up questions to collect clarification. This step transforms the input into a machine-readable set of semantic objects.

At step 1415, the hierarchical tag graph module 222 may classify the extracted information into a primary domain tag and a sub-domain tag. The module may evaluate metadata associated with domain-category nodes and sub-domain nodes to determine which tags match the extracted semantic features. This classification may involve weighted scoring, rule evaluation, and similarity assessments. The selected tags define the domain-specific operational rules applicable to the workflow. The module outputs a classification object linking the script input to domain metadata.

At step 1420, the context resolver 224 may evaluate geographic indicators, regulatory indicators, and contextual signals to determine the governing context. The system may analyze explicit textual location references, inferred regional cues, and stored user profile data. The context resolver 224 may then combine domain classification results with contextual findings to produce a governing context object. This governing context object includes jurisdictional requirements and procedural constraints. It is forwarded to workflow generation modules.

At step 1425, the milestone directed acyclic graph compiler 226 may generate milestone definitions using the primary domain tag, sub-domain tag, and governing context. The compiler may create milestones containing preconditions, client action items or professional action items, and verified events, and may then arrange these milestones into a Directed Acyclic Graph. The compiler may also determine logical dependencies between milestones based on extracted time references and contextual rules. This Structured Graph object fully represents procedural requirements. The system stores this graph in memory for further processing.

At step 1430, the cost binder 230 may generate structured cost objects 232 for each milestone. This operation may include applying domain-specific cost templates, computing resource estimates, and enforcing variance limiters. Each structured cost object 232 may contain values for fees, time commitments, or material requirements. The system may integrate these cost objects into the milestone structure 228 to create unified workflow-cost mappings. These objects provide financial structure to the workflow.

At step 1435, the engagement generator 234 may create an engagement agreement 236 using the milestone structure 228 and structured cost objects 232. The engagement generator 234 may populate template documents with milestone descriptions, cost information, preconditions, and user obligations. The engagement agreement 236 may be formatted for electronic signature and may include metadata linking it to specific workflow nodes. The system may store the completed agreement and present it to the user for execution. This step binds procedural and financial structures into a single contractual object.

At step 1440, upon execution of the engagement agreement 236, the runtime workflow tracker 238 may begin monitoring the execution of milestones. The tracker may detect verified events, update milestone statuses, and trigger dependent milestones according to the Directed Acyclic Graph produced at step 1425. The runtime workflow tracker 238 may communicate with user interfaces or professional dashboards to request required actions. It may also detect workflow delays and request additional information as needed. This step activates the procedural workflow.

At step 1445, the system may generate audit-log entries 240 to document key workflow events, milestone completions, and system actions. Each audit-log entry 240 may include timestamps, role identifiers, event identifiers, and hash-linked integrity information. The audit log provides an immutable record of system behavior and user interactions. These records may support compliance, review, or troubleshooting. This step closes the system-wide data transformation pipeline.

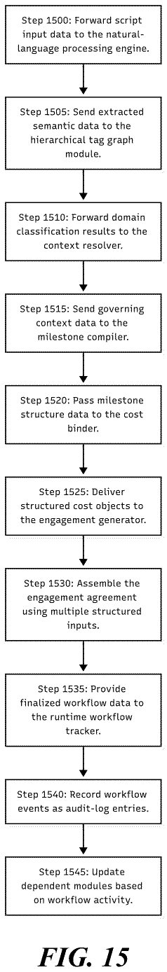

Referring to FIG. 15, a flowchart illustrates the multi-module interaction flow that occurs as data moves between the script input module 218, natural-language processing engine 220, hierarchical tag graph module 222, context resolver 224, milestone directed acyclic graph compiler 226, cost binder 230, engagement generator 234, and runtime workflow tracker 238. The steps shown in FIG. 15 represent a coordinated series of computer-implemented data transfers, each of which modifies the underlying data structures and prepares them for downstream modules. The order shown may occur sequentially or may include parallel execution paths depending on system configuration. Each referenced numeral reflects a discrete machine process performed by one or more processors executing instructions stored in memory. This figure emphasizes the technical interdependencies that characterize the platform's computational architecture.

At step 1500, the script input module 218 may capture a script input and transmit the normalized textual or document content to the natural-language processing engine 220. The script input module 218 may send associated metadata such as timestamps, source identifiers, and content categories to improve downstream accuracy. The system may ensure secure data transfer using internal messaging channels. The script input module 218 may also notify the processing layer 244 that content is ready for semantic extraction. This step begins the chain of interactions across multiple modules.

At step 1505, the natural-language processing engine 220 may produce extracted entities, intents, time references, and obligations and may forward these extracted features to the hierarchical tag graph module 222. The natural-language processing engine 220 may also attach semantic weights or confidence values to assist with domain classification. The transfer may occur via structured objects formatted for graph-based analysis. The system may record the transfer event for internal data-tracking purposes. This step passes machine-readable semantic content downstream.

At step 1510, the hierarchical tag graph module 222 may classify the extracted features into a primary domain tag and a sub-domain tag before sending the classification object to the context resolver 224. This module may also include internal node identifiers, rule-weights, or link pointers that describe the classification decision. The classification object may provide domain-specific constraints and metadata needed for context determination. The system may store an archival version of this classification object for system integrity. This step routes domain-aware information to the next component.

At step 1515, the context resolver 224 may combine classification results with contextual inference signals before passing a governing context object to the milestone directed acyclic graph compiler 226. This context object may include jurisdictional indicators, regulatory parameters, location metadata, and temporal constraints. The context resolver 224 may produce confidence metrics and reasoning metadata. This object ensures that the Directed Acyclic Graph will reflect governance rules applicable to the script input. This step establishes legally or procedurally relevant context for workflow generation.

At step 1520, the milestone directed acyclic graph compiler 226 may generate a preliminary milestone structure 228 and forward its structural output to the cost binder 230. This structural output may contain milestones, preconditions, client action items or professional action items, and verified events. The Directed Acyclic Graph may be serialized for efficient transport and may include node identifiers and edge relationships. The system may propagate this early milestone structure to additional modules for refinement. This step initiates procedural structuring of the workflow.

At step 1525, the cost binder 230 may create structured cost objects 232 and return cost-enhanced milestone details back to the engagement generator 234. The cost binder 230 may evaluate fees, resource requirements, and variance limiter conditions. Each structured cost object 232 may bind a cost profile to a milestone node within the Directed Acyclic Graph. These cost objects may include numerical values, adjustable fields, and attached metadata. This transmission ensures that financial elements are included in the contract assembly process.

At step 1530, the engagement generator 234 may assemble milestone details, structured cost objects, and context metadata to create an engagement agreement 236. It may incorporate template components based on the domain classification and governing context. The engagement generator 234 may also embed verification instructions and action-item references that correspond to specific Directed Acyclic Graph nodes. The system may store a draft agreement and forward it to the display module 216 for user execution. This step integrates multiple structured data objects into a binding document.

At step 1535, the runtime workflow tracker 238 may receive the finalized milestone structure 228 and engagement agreement 236 after execution. This tracker may activate milestones, monitor preconditions, detect verified events, and trigger dependent tasks based on the Directed Acyclic Graph. It may also transmit status updates to the communication module 202 and display module 216. The runtime workflow tracker 238 may provide real-time monitoring and user notification functions. This step begins the operational execution of the workflow.

At step 1540, verified events detected by the runtime workflow tracker 238 may be transmitted to audit-log entries 240. Each event may include timestamps, role identifiers, event identifiers, and contextual metadata. Audit-log entries 240 may store this information securely using hashing or chain-linked integrity mechanisms. The system may periodically verify log integrity and ensure that all events remain traceable. This step closes the multi-module interaction flow by producing persistent machine-generated records.

At step 1545, the system may optionally update dependent modules such as the milestone directed acyclic graph compiler 226 or cost binder 230 based on newly detected events. The runtime workflow tracker 238 may also trigger re-evaluation of preconditions or initiate follow-up question requests. This final interaction step ensures that data changes propagate through the system and that all modules maintain synchronized workflow states. The system may archive a final snapshot of the workflow state for compliance or post-processing.

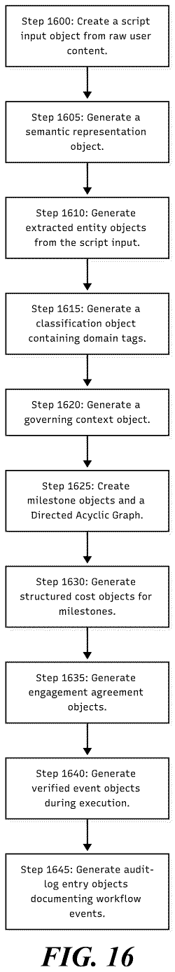

Referring to FIG. 16, a flowchart illustrates the lifecycle of machine-generated data structures produced and transformed by the application program 200. The flowchart depicts how the system converts natural-language content into semantic objects, classification objects, governing context objects, milestone objects, structured cost objects, and engagement agreement objects, before producing audit-log entries 240 during workflow execution. The steps shown in FIG. 16 represent a series of computer-implemented operations that modify data formats, structures, and content in ways that cannot be performed manually. These operations may occur sequentially, in parallel, or through event-driven triggers. Reference numerals 1600 through 1645 correspond to the lifecycle stages included in this figure.

At step 1600, the script input module 218 may generate a script input object from raw natural-language text, voice-to-text data, or document information. The script input object may include normalized content, extracted text, user identifiers, timestamps, and metadata describing the input source. This object may be stored in memory and prepared for downstream processing. The script input object represents the initial unstructured state in the data lifecycle. This step begins the transformation from raw input to structured data.

At step 1605, the natural-language processing engine 220 may generate a semantic representation object from the script input object. This representation may include tokenized segments, part-of-speech annotations, dependency structures, and other linguistic features. The semantic representation object may support accurate extraction of entities, intents, time references, and obligations. This intermediate object may be used internally but may not travel downstream. This step converts normalized text into linguistic structures.

At step 1610, the natural-language processing engine 220 may generate extracted entity objects, each containing labeled entities, identified intents, associated time references, and obligations. These objects may include structured fields, confidence scores, and semantic metadata. Extracted entity objects may also identify ambiguous or missing information that the system may later resolve. The extracted entity objects may be delivered to the hierarchical tag graph module 222 and context resolver 224 for classification and context analysis. This step creates the first fully machine-interpretable objects.

At step 1615, the hierarchical tag graph module 222 may generate a classification object that includes the primary domain tag and sub-domain tag. The classification object may also include internal node references, rule weights, and metadata describing how the classification was determined. The classification object may form the foundation for selecting procedural rules, required documents, and legal or operational frameworks. It may be stored for cross-referencing during workflow generation. This step provides domain and sub-domain structure to the extracted data.

At step 1620, the context resolver 224 may generate a governing context object comprising jurisdictional information, regulatory constraints, geographic indicators, and temporal qualifiers. This object may integrate contextual signals from the script input, extracted entity objects, and user metadata. The governing context object may determine which procedures, rules, and milestone structures are applicable. It may be passed to the milestone directed acyclic graph compiler 226 for procedural generation. This step adds governing structure to domain-classified data.

At step 1625, the milestone directed acyclic graph compiler 226 may generate milestone objects that contain preconditions, client action items or professional action items, and verified events. Each milestone object may include identifiers linking it to other milestones and may include metadata describing procedural logic. The compiler may also generate a Directed Acyclic Graph object representing milestone ordering, dependencies, and execution rules. These objects represent the core procedural structures that define workflow logic. This step transitions from classification to actionable workflow objects.

At step 1630, the cost binder 230 may generate structured cost objects 232 corresponding to each milestone object. These structured cost objects may include cost estimates, resource calculations, variance-limiter parameters, and references to their associated milestones. The system may serialize each structured cost object for consistent interpretation by downstream modules. Structured cost objects may also support billing and invoicing functions. This step incorporates financial data into the workflow data lifecycle.

At step 1635, the engagement generator 234 may generate engagement agreement objects based on milestone objects and structured cost objects. Engagement agreement objects may include text fields, references to action items, cost provisions, and document signatures. These objects may also embed milestone identifiers and workflow references. Engagement agreement objects may reside within the database engine 204 for user execution and post-processing. This step unifies procedural and financial data into a contractual structure.

At step 1640, the runtime workflow tracker 238 may generate verified event objects during workflow execution. These objects may represent document uploads, digital signatures, timestamped confirmations, or automated system validations. Verified event objects may be used to update milestone objects, activate downstream milestones, and track workflow state. They may include integrity fields for consistency verification. This step reflects real-time updates to active workflow data.

At step 1645, the system may generate audit-log entry objects 240 containing metadata linked to verified events, milestone updates, and system actions. These entry objects may include timestamps, role identifiers, event identifiers, and hashed integrity chains. The audit-log entry objects may be stored in the database engine 204 for compliance and review. This step completes the lifecycle of structured data objects generated by the system. The lifecycle illustrates machine-driven transformations from raw text to executed workflow states.

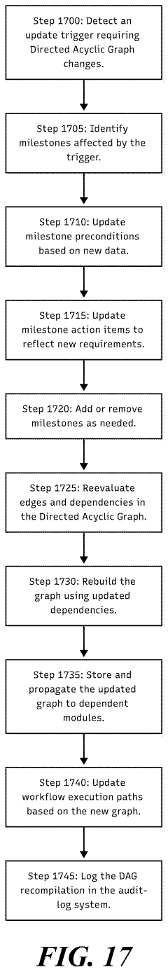

Referring to FIG. 17, a flowchart illustrates operations performed when the milestone directed acyclic graph compiler 226 dynamically recompiles all or part of the Directed Acyclic Graph in response to new information or verified events detected by the runtime workflow tracker 238. FIG. 17 demonstrates how the system algorithmically restructures workflow logic using updated data structures, dependency evaluation, and procedural recalculation. These operations may occur during workflow execution when changes affect milestones, preconditions, or contextual assumptions. The flowchart highlights technical processes that cannot be performed without specialized computing resources. Each operation is identified by a reference numeral between 1700 and 1745.

At step 1700, the runtime workflow tracker 238 may detect a trigger event requiring recompilation. This trigger event may include a newly verified event, a user response to a follow-up question, uploaded documentation, or updated contextual information from the context resolver 224. The runtime workflow tracker 238 may package this information into an update trigger object and forward it to the milestone directed acyclic graph compiler 226. The system may log the trigger in audit-log entries 240 for traceability. This step initiates the DAG recompilation cycle.

At step 1705, the milestone directed acyclic graph compiler 226 may identify all milestones affected by the update trigger. This may include milestones with preconditions dependent on newly received information or those affected by changes in domain classification or governing context. The compiler may analyze dependency chains within the Directed Acyclic Graph and determine which nodes require recalculation. It may also mark dependent nodes for further evaluation. This step ensures that recompilation focuses on relevant graph segments.

At step 1710, the compiler may update milestone preconditions using the new information. The system may mark preconditions as satisfied, unsatisfied, or re-evaluated based on the trigger. If the update invalidates a precondition, the system may adjust milestone eligibility. This step may also generate new follow-up questions if the update reveals additional missing information. This ensures milestone integrity before structural updates.

At step 1715, the compiler may update client action items or professional action items within affected milestones. This may include reassigning responsibilities, modifying required tasks, or inserting new tasks based on updated procedural requirements. The compiler may evaluate regulatory metadata, domain rules, or contextual constraints to determine correct action assignment. Updated action items may be stored in the milestone structure 228. This step modifies functional responsibilities within the workflow.

At step 1720, the compiler may identify whether any milestones must be added or removed due to changed circumstances. Conditions may arise where the updated information indicates new procedural requirements or eliminates previously necessary tasks. The compiler may construct new milestone objects or deprecate obsolete ones. Each change may include updates to preconditions, action items, and verified events. This step accommodates dynamic workflow expansion or reduction.

At step 1725, the milestone directed acyclic graph compiler 226 may analyze milestone dependencies and edge relationships within the Directed Acyclic Graph. This analysis may include evaluating temporal sequences, conditional branching paths, and execution prerequisites. The compiler may determine whether existing edges require removal or reordering. It may also identify new dependency paths resulting from updated milestone content. This step prepares the system for graph reconstruction.

At step 1730, the system may rebuild the affected portion of the Directed Acyclic Graph. The compiler may remove outdated nodes, add new nodes, and update edge relationships to preserve acyclic structure. Rebuilding may occur as a localized, partial reconstruction or as a full graph regeneration, depending on the scope of changes. The compiler may run a cycle-detection routine to ensure the graph remains valid. This step reestablishes a deterministic workflow model.

At step 1735, the updated Directed Acyclic Graph may be stored within the milestone structure 228 and propagated to dependent modules. This propagation may include sending updates to the runtime workflow tracker 238, cost binder 230, and engagement generator 234 if structural changes affect cost or contractual terms. The system may also persist the updated DAG for future retrieval. This step ensures system-wide synchronization.

At step 1740, the runtime workflow tracker 238 may update workflow execution paths based on the new Directed Acyclic Graph. The tracker may activate or deactivate milestones as needed and may notify users of any changed responsibilities. It may also adjust monitoring of verified events to reflect updated dependencies. This step aligns workflow execution with updated logic.

At step 1745, the system may generate audit-log entries 240 documenting the DAG recompilation, affected milestones, updated dependencies, and propagated changes. The audit-log entries 240 may include timestamps, event identifiers, and integrity hashes linking them to prior records. These entries may support review, compliance verification, or error analysis. This step concludes the dynamic DAG recompilation process.

In some embodiments, the system may include a broad classification engine that serves as an alternative to the hierarchical tag graph module 222. The broad classification engine may associate a script input with one or more domain tags without requiring a primary domain tag or a sub-domain tag. The broad classification engine may compare extracted entity objects, intents, obligations, and contextual metadata against classification templates, embeddings, vector similarity spaces, or neural network outputs to identify the domain or category associated with the script input. The classification engine may produce one or more domain tags that are used by the context resolver 224 and the milestone directed acyclic graph compiler 226 to generate milestone structures. This embodiment may support classification schemes that do not rely on hierarchies, tiered labels, or graph relationships.

In some embodiments, the system may include a fallback legal workflow embodiment in which the script input corresponds specifically to a legal matter. The natural-language processing engine 220 may extract legal entities, legal intent indicators, governing law indicators, statutory references, or procedural obligations. The broad classification engine or hierarchical tag graph module 222 may map the script input to a legal category and a legal subcategory, such as civil litigation or landlord tenant disputes. The context resolver 224 may determine a governing legal jurisdiction based on extracted geographic indicators or metadata. The milestone directed acyclic graph compiler 226 may generate legal milestones associated with client action items or attorney action items. This embodiment provides a minimal legal workflow configuration that may be used as a fallback enabled structure.

In some embodiments, the natural-language processing engine 220 may utilize transformer models, large language models, embedding vectors, similarity search engines, or agent-based pipelines to classify content and extract semantic meaning. The system may treat the natural-language processing engine 220 as a general artificial intelligence component that can perform rule based inference, supervised or unsupervised learning, or generative semantic parsing. Extracted objects may include entities, intents, obligations, time references, procedural indicators, and contextual qualifiers that are derived from embeddings or model predictions. These alternative implementations allow the system to operate with evolving AI models and may support classification methods that do not rely exclusively on predefined linguistic rules. The outputs from these models may be used identically to outputs produced by more traditional NLP engines.

In some embodiments, workflow generation may use alternative architectures that replace the Directed Acyclic Graph structure produced by the milestone directed acyclic graph compiler 226. The system may generate generative task sequences, state machines, rule based decision engines, or flat task lists that do not rely on graph nodes and edges. These workflow architectures may still define milestone dependencies, ordering constraints, branching paths, and verification conditions, but may use alternative data structures to express them. The system may map milestones to execution paths within these architectures and produce milestone structure objects that reference procedural logic. The runtime workflow tracker 238 may evaluate progress using state transitions or rule outcomes. This embodiment prevents a narrow interpretation that limits workflow representations to Directed Acyclic Graphs.

In some embodiments, structured cost objects 232 may support alternative cost representations that differ from per milestone cost binding. Structured cost objects may represent hourly billing values, subscription billing values, flat fees, metered usage fees, contingent billing values, or hybrid pricing combinations. The cost binder 230 may generate structured cost objects that specify the pricing model, cost parameters, and associations with workflow elements that may or may not be milestones. These objects may update when milestones are completed, when specific verified events occur, or when the dynamic billing engine 254 detects deviations in actual workload relative to expected workload. Alternative pricing models allow flexible cost binding across different workflow architectures.

In some embodiments, the dynamic billing engine 254 may detect deviations between expected workload and actual runtime execution conditions. Such deviations may include scope expansion, additional document requirements, unexpected events, prolonged delays, or additional approval steps. When deviations exceed configured thresholds, the dynamic billing engine 254 may generate a switch candidate event and pause workflow execution. The engine may recompile structured cost objects 232 to switch from milestone based pricing to time and materials pricing or hybrid pricing. The engine may also generate an addendum to the engagement agreement 236 and track billing updates through verified event objects.

In some embodiments, the system may support collective or cohort workflows. The cohort grouping and collective workflow engine 256 may detect similarity between script inputs submitted by multiple users based on extracted entities, intents, obligations, or contextual metadata. When similarity thresholds are satisfied, the system may form a cohort and generate a shared milestone structure containing cohort level milestones and individual milestones. The system may support additional features such as group communication channels, cohort voting structures, or shared cost models. The runtime workflow tracker 238 may monitor both group level milestones and individual milestones, and may trigger cohort verified events when conditions are met.

In some embodiments, the system may include a routing engine configured to select a workflow pathway using scoring engine outputs, domain classification values, governing context values, and structured cost objects. The routing engine may select between a self action workflow, a professional managed workflow, a community based workflow, or a cohort workflow depending on the scoring values. The routing engine may evaluate case worthiness, client readiness, and professional suitability values produced by the scoring engine 252. It may also determine whether further preconditions or documents are required before workflow activation. Updated routing decisions may cause the routing engine to trigger directed acyclic graph recompilation or alternative workflow regeneration.

In some embodiments, the system may expand entity extraction capabilities beyond traditional entity objects. The natural-language processing engine 220 may identify people, organizations, geographic locations, dates, document types, events, actions, obligations, triggers, evidentiary indicators, financial entities, regulatory standards, urgency indicators, and roles. Extracted entities may include structured metadata describing probabilistic confidence, contextual qualifiers, or relational links. These expanded entity types may support more detailed downstream classification, scoring, and workflow generation functions. Extracted entity objects may be consumed by the hierarchical tag graph module 222 or the broad classification engine.

In some embodiments, the roles, permissions, and matching modules 258 may generate role identities that define participant capabilities, access privileges, jurisdictional limits, and action item assignments. These modules may match professional participants with workflows based on classification values, governing context, professional licensing, specialization tags, or case worthiness scores. The modules may update permissions dynamically as workflow conditions evolve. The display module 216 may reflect permissions changes to ensure participants only view or modify workflow components they are authorized to access. The runtime workflow tracker 238 may notify participants when their assigned roles require action.

In some embodiments, the system may support script inputs that include images, photographs, scans, or screenshots. The script input module 218 may preprocess visual content using optical character recognition or computer vision models, and may extract textual and non textual features from the images. The natural-language processing engine 220 may integrate these features with linguistic extraction results. Classification engines may infer domain or subdomain values from visual cues alone, such as property damage, product defects, or document images. The system may treat visual content as a first class script input source.

In some embodiments, the system may include a learning engine that updates classification parameters, scoring parameters, workflow selection parameters, or cost estimation parameters based on prior workflow outcomes. The learning engine may collect data regarding outcome quality, completion times, cost deviations, user satisfaction, or milestone delays. The learning engine may store these outcomes in a workflow outcome store and adjust internal model parameters. Updated parameters may inform classification decisions, milestone generation rules, or pricing estimates. Safeguards and versioning may ensure that updates do not invalidate prior workflows.

In some embodiments, the system may support alternative context resolution implementations that use probabilistic inference, rule weighting, or vector similarity analysis. The context resolver 224 may incorporate historical context patterns or user profile metadata. Governing context objects may include composite indicators that represent probabilistic jurisdictional or regulatory assignments. The milestone directed acyclic graph compiler 226 may generate workflows using these expanded context definitions. Updated context may trigger dynamic recompilation as conditions change.

In some embodiments, the milestone tracker 260 may support concurrent multi workflow supervision for users participating in multiple workflows. The tracker may integrate with the display module 216 to present a consolidated milestone timeline. It may detect conflicts or dependencies between workflows and may notify participants when actions in one workflow impact another. The tracker may also coordinate shared verified events across related workflows. These multi workflow capabilities support advanced coordination patterns.

In some embodiments, the system may support a hybrid workflow representation that uses Directed Acyclic Graphs for deterministic components and generative sequences for flexible components. The milestone directed acyclic graph compiler 226 may generate the fixed pathway, while a generative sequence engine may create adaptive tasks. Structured cost objects may bind to deterministic milestones or to dynamic tasks depending on workflow configuration. The runtime workflow tracker 238 may monitor both parts of the workflow. This hybrid approach supports adaptable workflow structures.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A computer-implemented system comprising one or more processors and one or more memory devices storing instructions that, when executed by the one or more processors, cause the system to perform operations comprising:
receiving, via a user interface, a script input comprising one or more of natural-language text, voice-generated text, image content, or document information;
processing the script input using a natural-language processing engine configured to extract semantic features comprising at least one of entities, intents, time references, and obligations from the script input;
classifying the script input using a classification engine configured to associate the script input with one or more domain tags or classification labels based on at least one of entities, intents, time references, or obligations extracted from the script input or associated metadata;
determining, using a context resolver, a governing context applicable to the script input based on context data comprising at least one of the one or more domain tags, one or more geographic indicators, one or more regulatory indicators, user-specified jurisdiction information, or stored user profile metadata;
generating, using a workflow generation component, a workflow structure comprising a plurality of workflow components, wherein at least some of the workflow components comprise at least one action item associated with a client role or a professional role, and wherein at least some of the workflow components further comprise at least one precondition or at least one verified event, and wherein the workflow structure defines dependency-resolved execution relationships for at least some of the workflow components;
associating, using a cost engine, one or more structured cost objects with at least a portion of the workflow components; and
generating, using an engagement generator, an engagement agreement comprising terms derived from at least some of the workflow components and pricing terms derived from the one or more structured cost objects.

2. The system of claim 1, wherein the operations further comprise: executing, using a workflow execution component, the workflow structure by detecting completion of one or more verified events and updating workflow status based on the detected completion.

3. The system of claim 1, wherein the classification engine comprises a hierarchical tag graph module configured to associate the script input with a primary domain tag and a sub-domain tag.

4. The system of claim 3, wherein the hierarchical tag graph module comprises hierarchical nodes representing domain categories, sub-domain categories, regulatory relationships, or inheritance rules, each node stored with metadata describing governing rules, required documents, responsible roles, or time-and-cost parameters.

5. The system of claim 1, wherein the classification engine comprises a machine-learning classifier configured to generate the one or more domain tags using vector embeddings, similarity search, a transformer model, a neural network, or a large-language-model-based classifier.

6. The system of claim 1, wherein the natural-language processing engine is implemented using at least one model type selected from the group consisting of rule-based models, traditional machine-learning models, transformer models, embedding-based semantic models, and agent-based orchestration pipelines.

7. The system of claim 1, wherein the workflow generation component comprises a milestone directed acyclic graph compiler configured to compile the workflow structure into a directed acyclic graph representing task sequencing, dependency relationships, and execution order.

8. The system of claim 7, wherein the milestone directed acyclic graph compiler is further configured to, responsive to a runtime workflow tracker detecting a verified event that modifies a workflow condition associated with a workflow component, recompile the directed acyclic graph to update at least one of: (i) an execution order of workflow components, (ii) a precondition associated with a workflow component, or (iii) a dependency relationship between workflow components.

9. The system of claim 7, wherein the workflow generation component is further configured to generate an alternative workflow representation comprising a conditional task sequence, a state machine, a rule-based decision engine, or a generative task sequence that encodes milestone dependencies without an explicit directed acyclic graph data structure.

10. The system of claim 1, wherein the cost engine is configured to generate the one or more structured cost objects that specify one or more pricing models selected from milestone-based fixed-fee pricing, hourly pricing, subscription pricing, usage-based pricing, contingent pricing, or hybrid pricing combinations, and to associate each structured cost object with at least one workflow component or verified event.

11. The system of claim 10, further comprising a dynamic billing engine configured to detect deviations between expected workload and actual workflow execution and, in response to determining that a deviation exceeds a threshold, to switch at least a portion of the workflow from milestone-based pricing to at least one of hourly pricing, usage-based pricing, or hybrid pricing and update corresponding pricing terms in the engagement agreement or an addendum.

12. The system of claim 1, further comprising a scoring engine configured to compute one or more of a case-worthiness score, a client-readiness score, or a professional-suitability score based on extracted entities, intents, obligations, the governing context, or workflow metadata.

13. The system of claim 12, further comprising a routing engine configured to select, based on at least one of the one or more domain tags, the governing context, the structured cost objects, or outputs of the scoring engine, a workflow mode from among a self-action workflow, a professionally managed workflow, a community forum, and a cohort workflow, and, in response to changes in scoring engine outputs or workflow conditions, to switch between the workflow modes.

14. The system of claim 1, further comprising a matching engine configured to select one or more professional participants based on at least one of licensing information, jurisdictional eligibility, specialization tags, workload availability, or professional-suitability score.

15. A computer-implemented method for transforming a script input into an executable workflow, the method comprising:
receiving, via a user interface, a script input comprising one or more of natural-language text, voice-generated text, image content, or document information;
processing the script input using a natural-language processing engine configured to extract semantic features comprising at least one of entities, intents, time references, and obligations from the script input;
classifying the script input using a classification engine configured to associate the script input with one or more domain tags or classification labels based on at least one of entities, intents, time references, or obligations extracted from the script input or associated metadata;
determining, using a context resolver, a governing context applicable to the script input based on context data comprising at least one of the one or more domain tags, one or more geographic indicators, one or more regulatory indicators, user-specified jurisdiction information, or stored user profile metadata;
generating, using a workflow generation component, a workflow structure comprising a plurality of workflow components, wherein at least some of the workflow components comprise at least one action item associated with a client role or a professional role, and wherein at least some of the workflow components further comprise at least one precondition or at least one verified event, and wherein the workflow structure defines dependency-resolved execution relationships for at least some of the workflow components;
associating, using a cost engine, one or more structured cost objects with at least a portion of the workflow components; and
generating, using an engagement generator, an engagement agreement comprising terms derived from at least some of the workflow components and pricing terms derived from the one or more structured cost objects.

16. The method of claim 15, further comprising generating one or more follow-up questions using the natural-language processing engine when one or more preconditions associated with a milestone are unmet.

17. The method of claim 15, wherein generating the milestone structure comprises determining task sequencing, dependency relationships, and execution order by compiling the milestone structure into a Directed Acyclic Graph.

18. The method of claim 15, wherein executing the milestone structure comprises triggering one or more payment events in response to detection of one or more verified events.

19. The method of claim 15, further comprising automatically adjusting one or more structured cost objects in response to identification of a change in the governing context or a change in the milestone structure.

20. The method of claim 15, further comprising generating a self-action workflow for execution by a user in response to a determination that no professional action item is required for the script input.

21. A non-transitory computer-readable medium storing instructions that, when executed by one or more processors, cause the one or more processors to perform operations comprising:
receiving, via a user interface, a script input comprising one or more of natural-language text, voice-generated text, image content, or document information;
processing the script input using a natural-language processing engine configured to extract semantic features comprising at least one of entities, intents, time references, and obligations from the script input;
classifying the script input using a classification engine configured to associate the script input with one or more domain tags or classification labels based on at least one of entities, intents, time references, or obligations extracted from the script input or associated metadata;
determining, using a context resolver, a governing context applicable to the script input based on context data comprising at least one of the one or more domain tags, one or more geographic indicators, one or more regulatory indicators, user-specified jurisdiction information, or stored user profile metadata;
generating, using a workflow generation component, a workflow structure comprising a plurality of workflow components, wherein at least some of the workflow components comprise at least one action item associated with a client role or a professional role, and wherein at least some of the workflow components further comprise at least one precondition or at least one verified event, and wherein the workflow structure defines dependency-resolved execution relationships for at least some of the workflow components;
associating, using a cost engine, one or more structured cost objects with at least a portion of the workflow components; and
generating, using an engagement generator, an engagement agreement comprising terms derived from at least some of the workflow components and pricing terms derived from the one or more structured cost objects.

22. The non-transitory computer-readable medium of claim 21, wherein the instructions further cause the one or more processors to execute, using a workflow execution component, the workflow structure by detecting completion of one or more verified events and updating workflow status based on the detected completion.

23. The non-transitory computer-readable medium of claim 21, wherein the instructions further cause the one or more processors, in response to detecting a verified event, to dynamically update at least one workflow component by modifying at least one of a precondition, an associated action item, a dependency relationship, or a workflow status.

24. The non-transitory computer-readable medium of claim 21, wherein the instructions further cause the one or more processors to generate, using the natural-language processing engine, one or more follow-up questions when at least one precondition associated with a workflow component is unmet.

25. A computer-implemented system for automated legal classification and matching, comprising:
a script input module configured to receive a script input;
a natural-language processing engine configured to process the script input and to extract semantic features comprising at least one of entities, intents, time references, and obligations from the script input;
a classification component configured to associate the script input with one or more legal domain tags or classification labels based on at least a portion of the extracted semantic features or the associated metadata; and
a matching engine configured to select one or more legal professional participants based on at least one of licensing information, jurisdictional eligibility, specialization tags, workload availability, or professional-suitability score.

26. The system of claim 25, wherein the system maintains role objects comprising one or more client role objects and one or more legal professional role objects, each role object including at least one of allowed actions, access permissions, or jurisdictional constraints, and wherein the matching engine is configured to associate the client role object with at least one of the legal professional role objects based on the one or more legal domain tags and at least one of licensing information or jurisdictional eligibility.

27. The system of claim 26, further comprising a workflow generation component configured to generate a workflow structure comprising a plurality of workflow components, wherein at least some of the workflow components comprise at least one action item associated with a client role or a legal professional role, wherein at least some of the workflow components further comprise at least one precondition or at least one verified event, and wherein the workflow structure defines dependency-resolved execution relationships for at least some of the workflow components.

28. The system of claim 27, wherein the workflow generation component is configured to generate a cohort workflow structure for a plurality of script inputs, the cohort workflow structure comprising cohort-level milestones, based on similarity detection across multiple script inputs using at least one of shared entities, recurring fact patterns, or shared harm indicators.
